(19) United States
(12) Patent Application Publication
(10) Pub. No.: US 2019/0337171 A1
(43) Pub. Date: Nov. 7, 2019

(54) SHAVING UNIT HAVING CUTTING UNITS WITH A FLUSH HOLE FOR CLEANING A HAIR COLLECTION CHAMBER

(71) Applicant: KONINKLIJKE PHILIPS N.V., EINDHOVEN (NL)

(72) Inventors: Reinier Niels LAP, SURHUIZUM (NL); Alwin William DE VRIES, ZUIDLAREN (NL); Marcus Cornelis PETRELLI, GRONINGEN (NL)

(21) Appl. No.: 16/479,947

(22) PCT Filed: Jan. 29, 2018
(86) PCT No.: PCT/EP2018/052032

§ 371 Date: Jul. 23, 2019

(30) Foreign Application Priority Data
Jan. 27, 2017 (EP) 17153524.8

(51) Int. Cl. B26B 19/38; B26B 19/14

(52) U.S. Cl. CPC B26B 19/382; B26B 19/3866; B26B 19/146; B26B 19/145

(57) ABSTRACT

The invention relates to a shaving unit for a shaving apparatus, comprising at least a first cutting unit (410a) and a second cutting unit (410b), wherein said first and second cutting units respectively comprise a first and a second external cutting member (460a), (460b) having a plurality of hair entry openings and a first and a second internal cutting member (480a), (480b) which is rotatable relative to, respectively, the first and the second external cutting member about, respectively, a first and a second axis of rotation (406a), (406b). The first and second internal cutting members are connected to a transmission unit via, respectively, a first and a second drive (spindle (476a), (476b). The cutting units each comprise a housing (420a) having a bottom wall (424a) which comprises an opening (425a) which is in fluid communication with a hair collection chamber (427a) in the housing. In each cutting unit a sealing structure (465a) is provided between the opening and the hair collection chamber, said sealing structure being configured and arranged to prevent cut hairs from escaping from the hair collection chamber via the opening and to allow water to flush via the opening to the hair collection chamber.

### FIELD OF THE INVENTION

The invention relates to a shaving unit for a shaving apparatus comprising at least two cutting units. Further, the invention relates to a shaving apparatus comprising such a shaving unit.

### BACKGROUND OF THE INVENTION

Shaving units and apparatuses are used for shaving, in particular for shaving a men's skin in the lower facial region and the neck region. In such shaving units, hairs which are to be cut enter through the hair entry openings in the external cutting members and are then cut by shearing forces exerted by the rotary motion of the internal cutting members in relation to the external cutting members. The edges of the hair entry openings provide cutting edges, and the internal cutting members have cooperating cutting edges in relative motion to the cutting edges of the hair entry openings to effect said shearing forces.

The cut hairs are received by the hair collection chambers of the cutting units and are accumulated therein. It is generally known to frequently open the cutting units of such shaving apparatus to remove the cut hairs out of the hair collection chambers and to clean the internal cutting members. This, however, is an inconvenient cleaning procedure, because it is required to open the cutting units to have access to the hair collection chambers. In addition, particular components of the cutting units, such as the internal cutting members, may need to be removed from the cutting unit by the user in order to clean the cutting units, and need to be mounted again in the cutting units after cleaning thereof. These operations require some basic technical skills of the user.

U.S. 2006/0156550 A1 discloses a shaver with a specific cleaning function. The shaver has three cutting units which are mounted in a common housing or shaving head and which have a common hair collection chamber. The shaver comprises flush water entry openings provided in a bottom wall of the hair collection chamber. Flush water may be provided via a water inlet port arranged below the hair collection chamber and may enter the hair collection chamber via the flush water entry openings. An impeller is provided near each of the flush water entry openings. Each impeller is driven by a drive spindle, which is also used to drive a respective one of the internal cutting members of the shaver. The impellers generate a flow of flush water, which enters the hair collection chamber via the flush water entry openings and leaves the hair collection chamber via the hair entry openings provided in the external cutting members. By this water flow, the hair collection chamber can be cleaned from cut-off hairs and other shaving debris.

While the cleaning function of this known shaver has proven to produce a good cleaning effect of the hair collection chamber, it is required to integrate specific impellers component to produce a sufficient cleaning effect. The impellers require a certain space and, thus, limit the options for further design optimizations of the cutting units, in particular with respect to the ability of the cutting units to pivot and to follow the skin contours. Further, the additional components, like the impellers, increase the number of steps required for manufacturing and mounting the shaver and, thus, increase the costs of the shaver.

WO 2006/067713 A1 discloses a shaver comprising a shaving unit with a central support member. The central support member comprises a coupling member by means of which the shaving unit can be detachably coupled to a main housing of the shaver. The shaving unit comprises three cutting units which are supported by the central support member and which can each individually pivot relative to the central support member. The cutting units each comprise an external cutting member, an internal cutting member, and a housing accommodating the external cutting member and the internal cutting member. The coupling member accommodates a central drive shaft of the shaving unit, which drives a central gear wheel arranged in an upper portion of the central support member. Each cutting unit has a driven gear wheel coupled to its internal cutting member and driven by the central gear wheel. In one embodiment, the housings of the cutting units each have a substantially open bottom, which allows a good view on the cutting members and furthermore allows cut-off hairs to directly leave the cutting units via the open bottom into an open space surrounding the central support member. In another embodiment, the bottoms of the housings of the cutting units are closed, e.g. by means of small cups or discs, arranged to collect the cut-off hairs and prevent them from leaving the cutting units during shaving. The cups or discs may be detachably connected to the housings of the cutting units so as to allow collected hairs to be removed. A disadvantage of this embodiment is that, in order to clean the complete shaving unit, the cups or discs of all cutting units have to be opened and closed individually, and the hair collecting chamber of each cutting unit has to be cleaned individually.

### SUMMARY OF THE INVENTION

It is object of the invention to provide a shaving unit and a shaving apparatus with an improved functionality for cleaning the shaving unit from cut-off hairs and other shaving debris.

According to the invention, this object is achieved by a shaving unit for a shaving apparatus, comprising at least a first cutting unit and a second cutting unit, wherein the first cutting unit comprises a first external cutting member having a plurality of hair entry openings, a first internal cutting member which is rotatable relative to the first external cutting member about a first axis of rotation, and a first housing accommodating a first hair collection chamber; wherein the second cutting unit comprises a second external cutting member having a plurality of hair entry openings, a second internal cutting member which is rotatable relative to the second external cutting member about a second axis of rotation, and a second housing accommodating a second hair collection chamber; wherein the first housing and the second housing each comprise a bottom wall which comprises an opening which is in fluid communication with, respectively, the first hair collection chamber and the second hair collection chamber, wherein a sealing structure is provided between the opening and, respectively, the first hair collection chamber and the second hair collection chamber, said sealing structure being configured and arranged to prevent cut hairs from escaping from, respectively, the first hair collection chamber and the second hair collection chamber via the opening and to allow water to flush via the opening to, respectively, the first hair collection chamber and the second hair collection chamber.

According to the invention, the shaving unit comprises at least two cutting units and may in particular comprise three, four, five or even more cutting units. Each cutting unit comprises an external cutting member, which may be part of a cap structure and wherein a plurality of hair entry openings is provided. These hair entry openings may define a shaving track, which is preferably a circular shaving track. The hair entry openings may be provided as a plurality of openings, like circular bores or slit openings, preferably arranged in an annular surface region of the external cutting member.

The external cutting member has cutting edges provided at the hair entry openings, which interact with cutting edges provided on the internal cutting member which is rotatable relative to the external cutting member. By this rotation of the internal cutting member relative to the external cutting member, a shearing force is imparted by the cooperating cutting edges of the internal cutting member and the external cutting members on hairs which reach through the hair entry openings. This shearing or cutting force effects the shaving action.

Further, each cutting unit comprises a housing which accommodates a hair collection chamber wherein the cut hairs are to be collected. For this purpose, the hair collection chamber is arranged in such a position in relation to the internal cutting member and the external cutting member that hairs, which are cut by the interaction of the two cutting members, will be received in the hair collection chamber.

According to the invention, an individual hair collection chamber is accommodated in the housing of each of the cutting units. Thus, each of the cutting units has an individual hair collection chamber, separate from the hair collection chamber or chambers of the other cutting unit or units. In particular, as a result, the cutting units may be individually pivotal relative a central support member of the shaving unit about a pivot axis in order to achieve a skin-contour following property of the cutting units. I.e. each cutting unit may perform a pivotal motion relative to a central support member of the shaving unit independent of a pivotal motion or motions of the other cutting unit or cutting units.

According to the invention, the housing of each cutting unit accommodating the hair collection chamber comprises a bottom wall, and may further comprise side walls encompassing the hair collection chamber to laterally close the hair collection chamber and prevent cut-off hair to escape out of the hair collection chamber. According to the invention, an opening is provided in the bottom wall of the housing of each cutting unit. The opening generally allows flush water to enter through the opening into the hair collection chamber via a flow path from the opening to the hair collection chamber. A sealing structure is however included in the flow path between the opening and the hair collection chamber. The sealing structure is configured and arranged such that cut-off hairs are prevented from escaping from the hair collection chamber to the opening via the sealing structure, and thus are kept inside the hair collection chamber. It is to be understood that the sealing structure will prevent cut-off hairs to escape through the sealing structure out of the hair collection chamber in such a way that the cut-off hairs are prevented from passing through the sealing structure or the passing of cut-off hairs through the sealing gap is minimized. This configuration may be accomplished e.g. by a certain maximum width of a flow path in the sealing structure, i.e. a width which is sufficiently small so that cut-off hair cannot pass the sealing structure, or by a minimum length of a flow path in the sealing structure such that cut-off hairs are prevented from passing through said flow path, or by a specific geometry of a flow path in the sealing structure, e.g. an angled flow path, a labyrinth flow path or the like.

While the sealing structure completely or predominantly prevents cut-off hairs to pass through in the direction from the hair collection chamber to the opening in the bottom wall of the housing, according to the invention the sealing structure is configured and arranged to allow flush water to enter the cutting unit via the opening in the bottom wall and to pass through the sealing structure into the hair collection chamber. The flush water generally is able to pass through the sealing structure into the hair collection chamber as a result of its liquid state and low viscosity. As a result, a flush water flow can be provided via the opening in the bottom wall of the housing into the hair collection chamber. Said flush water flow entering the opening and passing through the sealing structure may remove cut-off hairs and other shaving debris out of the hair collection chamber. The flush water flow comprising the cut-off hairs and the other shaving debris may easily pass through the hair entry openings of the external cutting member and thus leave the hair collection chamber during the cleaning procedure of the shaving unit. As a result, an efficient cleaning is effected using both the hydraulic forces of a flush water flow in the hair collection chamber and the gravity forces, in that the hair collection chamber may be flushed in an upside-down orientation of the shaving unit with the hair entry openings of the shaving track facing in a downward direction.

According to the invention, a flow path from the bottom side to the top side of the cutting units—with reference to an upright orientation of the shaving unit during a normal shaving procedure—may be established, effecting a quick and complete removal of cut-off hairs and other shaving debris out of the hair collection chamber. For an effective cleaning, the shaving unit or the shaving apparatus with the shaving unit coupled thereto may be held in an upside-down orientation to allow an easy access of the flush water into the openings in the bottom walls of the cutting units. The cleaning efficiency by such flush water may be improved by simultaneously putting the internal cutting members into rotation. However a cleaning operation may also be performed with the internal cutting members being stationary. Generally, a rotation of the internal cutting members will assist in cleaning the hair collection chambers from cut-off hairs. However, an efficient flow for such cleaning effect may be achieved by the flush water entering through the opening and passing through the cutting units by hydraulic and gravity forces only, i.e. without a rotational movement of the internal cutting members.

In a first preferred embodiment of the shaving unit according to the invention, the sealing structure comprises opposed sealing surfaces provided on, respectively, the first internal cutting member and the second internal cutting member and on, respectively, the first housing and the second housing, respectively, and at least one of said opposed sealing surfaces, and preferably the sealing structure, is symmetrical relative to, respectively, the first axis of rotation and the second axis of rotation. According to this embodiment, a rotational symmetry of the sealing structure or at least one of the opposed sealing surfaces comprised in the sealing structure with respect to the axis of rotation of each cutting unit is provided. Such symmetry allows to establish the sealing structure between two parts of the cutting unit, in particular the internal cutting member and the housing, which are in rotational movement relative to each other, or allows to direct the flush water in an advantageous direction of flow into the hair collection chamber to effectively remove the cut-off hairs there from. Such a rotational symmetry may be provided by an annular sealing structure, e. g. having a ring-like geometry.

In a further preferred embodiment of the shaving unit according to the invention, the sealing structure is provided on a central carrying member of, respectively, the first internal cutting member and the second internal cutting member and on an edge structure of the opening in the bottom wall of, respectively, the first housing and the second housing cooperating with the central carrying member. According to this embodiment, in each cutting unit the sealing structure is provided between the internal cutting member and the opening in the bottom wall of the housing. The sealing structure may comprise a sealing gap between two components which are in relative motion to each other when the shaving unit is driven in operation. In particular, the sealing structure is established between a central carrying member, which serves to carry a cutting structure of the internal cutting member like a plurality of cutting edges provided at cutting blades or the like, and an edge structure around the opening in the bottom wall of the housing. In each cutting unit, said central carrying member cooperates to establish the sealing structure with the edge structure of the opening in the bottom wall of the housing. A sealing gap may be established between said edge structure and the central carrying member, such as to prevent cut-off hairs and other shaving debris from escaping out of the hair collection chamber via the opening and to allow flush water to enter via the opening into the hair collection chamber. The edge structure of the opening in the bottom wall may be a side wall of the opening, or a wall oriented substantially parallel to the axis of rotation and delimiting the opening in the bottom wall, or a wall oriented radially with respect to the axis of rotation. Preferably, the edge structure has a rotationally symmetric geometry relative to the axis of rotation of the respective cutting unit, such that a constant sealing gap is maintained during rotation of the internal cutting member in relation to the housing of the cutting unit.

In a preferred embodiment, the sealing structure comprises a first sealing gap which is symmetrical relative to and has a main direction of extension parallel to, respectively, the first axis of rotation and the second axis of rotation, wherein the first sealing gap is bounded by a first sealing surface provided on the central carrying member of, respectively, the first internal cutting member and the second internal cutting member and by a second sealing surface provided on the edge structure of the opening in the bottom wall of, respectively, the first housing and the second housing co-operating with the central carrying member, and wherein the first sealing surface and the second sealing surface are symmetrical relative to and have a main direction of extension parallel to respectively, the first axis of rotation and the second axis of rotation. According to this embodiment, a first sealing gap is provided which is arranged in a rotational symmetry relative to the axis of rotation of the cutting unit and is established between two sealing surfaces with a radial orientation relative to the axis of rotation. The first sealing gap is thus formed between two sealing surfaces with a main orientation perpendicular to the axis of rotation, wherein the orientation is to be understood to correspond to the direction of a surface normal of the sealing surface. It is to be understood that the first sealing gap is a part of the sealing structure and that the sealing structure may additionally comprise further sealing gaps. The first sealing gap is oriented to allow an axial shift of the two components establishing the first sealing gap between them, i.e. a shift parallel to the axis of rotation, to a certain extent without affecting the sealing function. The two components may in particular be the housing and the internal cutting member. Such an axial shift may e.g. result from wear of the internal cutting member or the external cutting member, and the orientation of the first sealing gap allows to maintain the functionality of the first sealing gap in case of such an axial shift of the internal cutting member relative to the housing of the cutting unit to compensate for such wear. As a result, the sealing function of the sealing structure is maintained during operation of the cutting unit over a long period of time, and wear of the internal and external cutting members will not reduce the sealing function and will not lead to an unwanted contact of the components providing the sealing structure.

In a further preferred embodiment, the first sealing gap, the first sealing surface and the second sealing surface are annular. Such an annular geometry will allow a rotational movement of the internal cutting member relative to the housing without any change of the sealing geometry during such rotational movement. It is to be understood that such an annular geometry may comprise geometries which slightly deviate from a perfectly circular geometry, like e.g. an elliptical geometry.

In a still further preferred embodiment, a minimum distance between the first sealing surface and the second sealing surface is in a range between 0.1 mm and 1.5 mm. It is to be generally understood that a minimum distance present between the first sealing surface and the second sealing surface will define the sealing function of the sealing structure to a large extent. A minimum distance in a range between 0.1 mm and 1.5 mm has shown to both provide an effective sealing to prevent cut-off hairs from passing through the sealing structure and at the same time allow flush water to pass through the sealing structure. It is to be understood that said minimum distance may be provided in one section of the first sealing gap, whereas the first sealing surface and the second sealing surface may have a larger mutual distance than 1.5 mm in other sections of the first sealing gap. Further, it is to be understood that the upper limit of the minimum distance may be lower than 1.5 mm, such as e.g. 1.25 mm, 1.00 mm, 0.75 mm or 0.50 mm.

In a still further preferred embodiment, the sealing structure comprises a second sealing gap which is symmetrical relative to and has a main direction of extension perpendicular to, respectively, the first axis of rotation and the second axis of rotation, wherein the second sealing gap is bounded by a third sealing surface provided on the central carrying member of, respectively, the first internal cutting member and the second internal cutting member and by a fourth sealing surface provided on the edge structure of the opening in the bottom wall of, respectively, the first housing and the second housing co-operating with the central carrying member, wherein the third sealing surface and the fourth sealing surface are symmetrical relative to and have a main direction of extension perpendicular to, respectively, the first axis of rotation and the second axis of rotation. According to this embodiment, a second sealing gap is established between two sealing surfaces provided on the internal cutting member and the housing of the cutting unit, and said third and fourth sealing surfaces have a main direction of extension perpendicular to the axis of rotation. The second sealing gap is thus formed between two sealing surfaces with a main orientation parallel to the axis of rotation. The sealing surfaces may thus be axially oriented surfaces, but may alternatively be surfaces with a slightly oblique orientation, i.e. an orientation having a main axial component and a relatively small radial component. The orientation of a sealing surface is to be understood to correspond to the direction of a surface normal of the sealing surface. As a result of the second sealing gap, a part of the sealing structure is provided wherein the flow through the sealing structure is provided in a radial direction with respect to the axis of rotation or at least in a direction with a main radial component. It is to be understood that the second sealing gap may be adjacent to the first sealing gap, such that the first and second sealing gaps together form an L-like geometry, seen in a longitudinal sectional view of the cutting unit along the axis of rotation.

In embodiments comprising such a second sealing gap, it is particularly preferred that the second sealing gap, the third sealing surface and the fourth sealing surface are annular. By such an annular geometry of the second sealing gap a rotational movement of the internal cutting member relative to the housing of the cutting unit is allowed without a change of the sealing geometry of the second sealing gap.

In embodiments comprising such a second sealing gap, it is further preferred that a minimum distance between the third sealing surface and the fourth sealing surface is in a range between 0.1 mm and 1.5 mm. It is to be generally understood that a minimum distance present between the third sealing surface and the fourth sealing surface will define the sealing function of the second sealing gap of the sealing structure to a large extent. A minimum distance in a range between 0.1 mm and 1.5 mm has shown to both provide an effective sealing function to prevent cut-off hairs from passing through the sealing structure, and at the same time allow flush water to pass through the sealing structure. It is to be understood that said minimum distance may be provided in one section of the second sealing gap, whereas the third sealing surface and the fourth sealing surface have a larger mutual distance than 1.5 mm in other sections of the second sealing gap. Further, it is to be understood that the upper limit of the minimum distance may be lower than 1.5 mm, e.g. 1.25 mm, 1.00 mm, 0.75 mm or 0.50 mm. The minimum distance between the third sealing surface and the fourth sealing surface in the second sealing gap may be larger than the minimum distance between the first sealing surface and the second sealing surface in the aforementioned first sealing gap.

In a further preferred embodiment of the shaving unit according to the invention, the first hair collection chamber and the second hair collection chamber are annularly arranged around the opening in the bottom wall of, respectively, the first housing and the second housing. According to this embodiment, in each cutting unit the hair collection chamber is arranged annularly around the opening in the bottom wall of the housing. The hair collection chamber may have a perfectly annular design around the axis of rotation, but the design may also deviate somewhat from such a perfectly annular design, for example to adapt the design of the hair collection chamber to a double, triple or quadruple arrangement of the cutting units adjacent to each other or in order to accommodate a pivoting structure for the cutting unit on the housing. Such a deviating design is to be understood to have an annular arrangement of the hair collection chamber around the axis of rotation of the cutting unit and around the opening of the housing, i.e. an arrangement wherein the hair collection chamber generally extends circumferentially around the opening such that any cut-off hairs falling from the external and internal cutting members in a downward direction is received by and collected in the hair collection chamber. Further, the annular arrangement of the hair collection chamber according to this embodiment results in an efficient flushing of the hair collection chamber by the annular inflow of the flush water through the opening and the distribution of the flush water flow in a radial direction into the hair collection chamber, with the flush water flow leaving the hair collection chamber via the hair entry openings.

In a further preferred embodiment of the shaving unit according to the invention, the first internal cutting member and the second internal cutting member are driven by, respectively, a first drive spindle and a second drive spindle extending through the opening in the bottom wall of, respectively, the first housing and the second housing. According to this embodiment, the opening in the bottom wall of the housing has a dual purpose. Beside the first function of providing access of flushing water for cleaning the cutting unit, a second function of the opening is to allow a coupling of the internal cutting member with the drive train of the shaving unit. This coupling is accomplished by a drive spindle which extends through the opening and couples with the internal cutting member to transfer a rotational movement and torque to the internal cutting member. It is to be understood that the flush water may pass through the opening laterally from the drive spindle in relation to a longitudinal axis of the drive spindle, such that the flush water passes through an annular gap between an inner wall delimiting the opening and the drive spindle.

Beside this, flush water may pass through the drive spindle itself in case the drive spindle is provided as a hollow component having openings allowing the flush water to enter into the drive spindle in positions of the drive spindle outside the housing of the cutting unit and to leave the drive spindle in positions of the drive spindle inside the housing of the cutting unit. This may further enhance the flush water flow and the flow volume to increase the cleaning effect.

It is to be understood further that the drive spindle may conduct a movement perpendicular to its longitudinal axis such as to follow a pivoting movement of the cutting unit. To allow such a movement of the drive spindle, a clearance between the drive spindle and the opening is provided such that the drive spindle will not come into contact with the inner wall of the opening in any pivoting position of the cutting unit.

In a further preferred embodiment of the shaving unit according to the invention, the shaving unit comprises a central support member comprising a coupling member by means of which the shaving unit can be releasably coupled to a main housing of the shaving apparatus, wherein the first drive spindle and the second drive spindle extend from a transmission unit to, respectively, the first cutting unit and the second cutting unit via an open space, which is present between the transmission unit and the first and the second cutting units and surrounds the central support member, and wherein the transmission unit is arranged between the coupling member and the open space. In this embodiment, the open space is to be understood to be open to the environment of the shaving unit and to thus allow a direct access for e.g. flush water from the environment into the open space. The drive spindles pass through the open space, and thus allow to arrange the transmission unit at a distance from the cutting units such that the open space between the transmission unit and the cutting units is sufficiently large for an easy supply of flush water via the open space into the openings in the bottom walls of the cutting units. The open space and the arrangement of the drive spindles extending from the transmission unit via the open space to the cutting units allow an efficient and convenient flushing of water through the openings provided in the bottom walls of the housings of the cutting units, since the water flow can be directed via the open space directly onto the bottom walls of the housings and thus directly enter into the opening in the bottom walls of the housings. The coupling member of the central support member may comprise a coupling structure for rigidly coupling the shaving unit to the main housing of a shaving apparatus accommodating a drive unit, like an electric motor. The central support member may comprise a transmission housing accommodating the transmission unit, and the coupling member may be provided at a lower side of the transmission housing. The transmission unit may have a suitable coupling element to couple a torque receiving part of the transmission unit to the drive unit of the main housing when the shaving unit is coupled to the main housing.

Generally, it is to be understood that the transmission unit may comprise transmission elements like a central transmission element engaging a first and a second driven transmission element which are coupled with, respectively, the first and the second cutting unit via, respectively, the first and the second drive spindle. Further driven transmission elements may be provided in the transmission unit in case corresponding further cutting units are incorporated in the shaving unit. The transmission elements may be gear wheels, like spur wheels, which are coupled to each other for torque transmission.

In a further preferred embodiment, the coupling member accommodates a central drive shaft arranged to drive the first and second drive spindles via a transmission assembly arranged in the transmission unit. According to this embodiment, the coupling member accommodates a central drive shaft which is adapted to be coupled to a drive unit, which is incorporated in the main housing of a shaving apparatus, when the shaving unit is coupled to the main housing by the coupling member. The central drive shaft is arranged to drive the first and second drive spindles via a transmission assembly, e.g. a gear assembly. Such a transmission assembly may comprise a central transmission element which is connected to the central drive shaft and arranged to drive corresponding first and second driven transmission elements, which are arranged laterally from the central transmission element with respect to the axis of rotation of the central transmission element and each connected to one of the respective drive spindles. The transmission assembly, incorporating said central transmission element and the driven transmission elements, is arranged in the transmission unit and may in particular be accommodated in a transmission housing to prevent flush water and debris from entering into the transmission unit.

In a further preferred embodiment, the first housing is pivotally mounted to the central support member by means of a first pivot axis and the second housing is pivotally mounted to the central support member by means of a second pivot axis. According to this embodiment, the cutting units are pivotal relative to the central support member in that the first housing and the second housing are coupled via a first pivot axis and second pivot axis, respectively, to the central support member. In particular, the cutting units may be individually and independently pivotal relative to the central support member, i.e. each cutting unit is able male a pivotal motion independent of a pivotal motion of the other cutting unit or units. The first and the second pivot axes may be parallel to each other or may even be coaxial, such that a compact design of the shaving unit can be realized by an arrangement of the two cutting units close to each other. In particular, the first and second pivot axes may be positioned between the first and the second cutting units, and the distance from the coinciding first and second pivot axes to the first axis of rotation may be identical to the distance of the coinciding first and second pivot axes from the second axis of rotation. It is to be understood that a coaxial arrangement of the first and second pivot axes does not influence a preferred independency of the pivotal motions of the cutting units about the first and second pivot axes.

A further aspect of the invention is a shaving apparatus comprising a main housing accommodating a motor, and comprising a shaving unit according to the invention as described beforehand, wherein the shaving unit is releasably coupled to the main housing. Said shaving apparatus may incorporate in said main housing a drive unit, like an electric motor, for driving the first and second cutting units and, if present, any further cutting unit when the shaving unit is coupled to the main housing. The shaving unit may comprise a centrally arranged coupling member by means of which the shaving unit can be releasably coupled to the main housing. The drive unit may drive the cutting units via a single central drive shaft accommodated in the coupling member of the shaving unit. The coupling member may comprise a suitable coupling structure adapted to mutually couple the main housing and the shaving unit. The coupling member may be provided on a central support member of the shaving unit which supports the cutting units.

It is to be understood that the shaving unit according to the invention and the shaving apparatus according to the invention may have similar and/or identical preferred embodiments, in particular, as defined in the dependent claims.

It is to be understood that a preferred embodiment of the present invention can also be any combination of the dependent claims or the above embodiments with the respective independent claim.

These and other aspects of the invention will be apparent from and elucidated with reference to the embodiments described hereinafter.

### BRIEF DESCRIPTION OF THE DRAWINGS

Preferred embodiments of the invention are described with reference to the drawings.

In the drawings:

FIGS. 1a-1c show a frontal view of three pivoted configurations of a shaving unit according to a first embodiment of the invention;

FIGS. 2a-2c show a side view of three pivoted configurations of the shaving unit of FIGS. 1a-1c;

FIG. 3 shows a cross-sectional view of the shaving unit of FIGS. 1a-1c along the line 1 in FIG. 4;

FIG. 4 shows a partial cut away top view of the shaving unit of FIGS. 1a-1c;

FIG. 5 shows a partially sectioned frontal view of parts of a shaving unit according to a second embodiment of the invention;

FIG. 6 shows a top view of the shaving unit of FIG. 5;

FIG. 7 shows a perspective, partially cut away upper-frontal view of the shaving unit of FIG. 5;

FIG. 8 shows a partial cut away perspective view of the shaving unit as shown in FIG. 7;

FIG. 9 shows a schematic top view of the arrangement of the primary pivot axes in a third embodiment of the shaving unit according to the invention;

FIG. 10 shows a schematic top view of the arrangement of the primary pivot axes in a fourth embodiment of the shaving unit according to the invention;

FIG. 11 shows a sectional frontal view of the shaving unit of FIGS. 1a-1c, depicting a drive train for the cutting units of the shaving unit;

FIG. 12 shows a sectional side view of the shaving unit of FIG. 11;

FIG. 13 shows a detailed view of a cutting unit and part of the drive train in the shaving unit of FIG. 11;

FIG. 14 shows a further detailed view of the shaving unit as shown in FIG. 13;

FIG. 15 shows a partial cross-sectional view of a detail of the shaving unit as shown in FIGS. 13 and 14 illustrating a flushing procedure of a cutting unit of the shaving unit;

FIG. 16 shows a top view onto a part of a housing of a cutting unit incorporated in the shaving unit of FIG. 11;

FIG. 17 shows a top view according to FIG. 16 with an external cutting member mounted into the housing; and

FIGS. 18a and 18b show a perspective view from an upper frontal side of a housing of the shaving unit of FIG. 11.

### DETAILED DESCRIPTION OF THE EMBODIMENTS

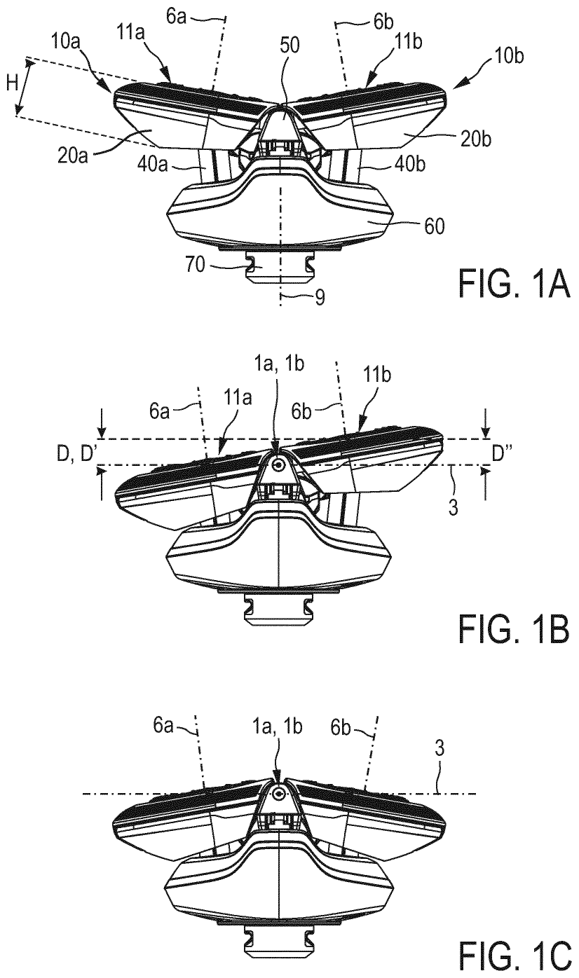

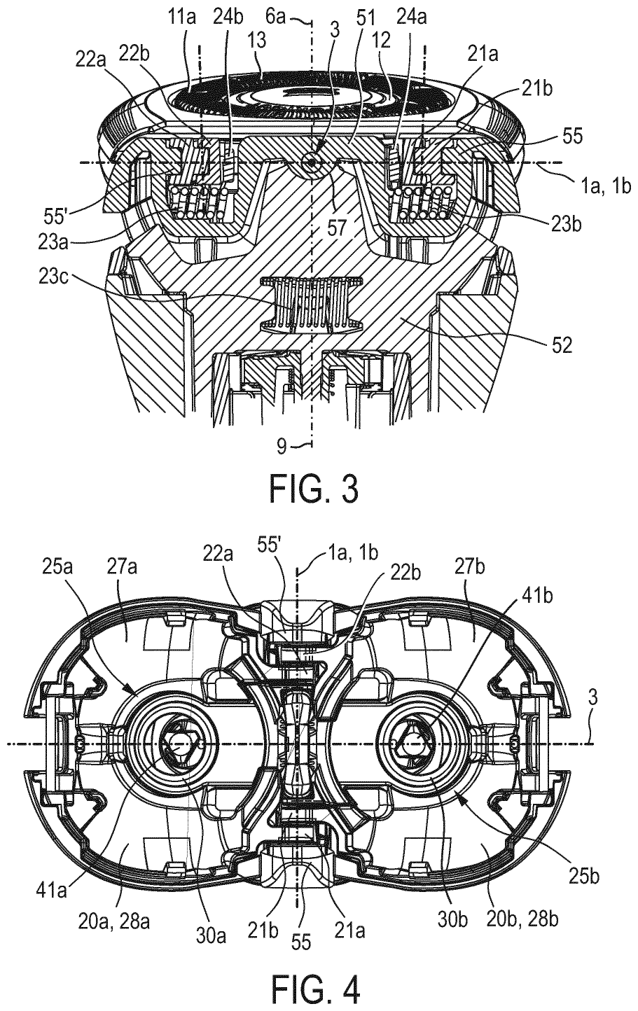

With reference to FIGS. 1a-1c a shaving unit for a shaving apparatus according to the invention is shown. The shaving unit has two cutting units, i.e. a first cutting unit 10a and a second cutting unit 10b, which are shown in three different pivoted positions with respect to each other. Each cutting unit 10a, 10b comprises an external cutting member 12, which is partially visible in FIG. 3. The external cutting member 12 comprises a plurality of hair entry openings 13, e.g. in the form of elongated slits. Via the hair entry openings 13, hairs present on the skin can enter the cutting units 10a, b. The hair entry openings 13 define a first shaving track 11a of the first cutting unit 10a and a second shaving track 11b of the second cutting unit 10b. In FIGS. 1a-1c the shaving tracks 11a, 11b are partially visible as protruding relative to, respectively, an upper surface of a first housing 20a of the first cutting unit 10a and an upper surface of a second housing 20b of the second cutting unit 10b. Each cutting unit 10a, 10b further comprises an internal cutting member, which is accommodated in the respective housing 20a, 20b and rotatable relative to the external cutting member 12 about a respective first and second axis of rotation 6a, 6b. The internal cutting members of the cutting units 10a, 10b are not visible in the FIGS. 1a-1c. They may have a structure with a plurality of cutting elements, as is well known for the person skilled in the art, and will not be described in further detail. Each internal cutting member is coupled via a respective drive spindle 40a, 40b to a transmission unit 60 of the shaving unit. The transmission unit 60 may comprise a set of transmission gear wheels for transmitting the rotational motion of a central drive shaft, which is rotatable about a main drive axis 9, into rotational motions of the drive spindles 40a, 40b. The central drive shaft, which is not visible in FIGS. 1a-1c, is accommodated in a coupling member 70 of the shaving unit. By means of the coupling member 70, the shaving unit can be releasably coupled to a main housing of the shaving apparatus, which is also not shown in the figures. The coupling member 70 is part of a central support member 50 of the shaving unit. The central support member 50 supports the first and second cutting units 10a, 10b.

The first housing 20a of the first cutting unit 10a is pivotally mounted to the central support member 50 by means of a first primary pivot axis 1a, and the second housing 20b of the second cutting unit 10b is pivotally mounted to the central support member 50 by means of a second primary pivot axis 1b. In the embodiment shown in FIGS. 1a-1c, the first and second primary pivot axes 1a, 1b coincide. The primary pivot axes 1a, 1b may also be non-coincident, i.e. they may constitute two separate parallel or non-parallel primary pivot axes about which the first and second cutting units 10a, 10b are pivotal relative to the central support member 50, respectively. In the embodiment shown in FIGS. 1a-1c, the first and second primary pivot axis 1a, 1c are arranged between the first and second axes of rotation 6a, 6b of the internal cutting members. More particular, seen in a direction parallel to the first axis of rotation 6a, the first primary pivot axis 1a is arranged between the first shaving track 11a and the second axis of rotation 6b and, seen in a direction parallel to the second axis of rotation 6b, the second primary pivot axis 1b is arranged between the second shaving track 11b and the first axis of rotation 6a. Such an arrangement of the primary pivot axes 1a, 1b is shown in FIGS. 1a-1c. Such an arrangement of the primary pivot axes 101a, 101b is also visible in the embodiment of the shaving unit as shown in FIG. 6, which will be further described hereinafter. In the embodiments of the shaving unit shown in FIGS. 1a-1c and in FIG. 6, seen in directions parallel to the first and second axes of rotation 6a, 6b, the first and second primary pivot axes 1a, 1b; 101a, 101b are in particular arranged between the external cutting members 12; 114a, 114b of the cutting units 10a, 10b; 110a, 110b, respectively. However, in an alternative embodiment of a shaving unit according to the invention, the primary pivot axes may be arranged in positions which are not or not fully between the external cutting members of the cutting units, e.g. in positions wherein the primary pivot axes cross the external cutting members in circumferential areas of the external cutting members. In the embodiment shown in FIGS. 1a-1c, however, the first primary pivot axis 1a is arranged between the first shaving track 11a and the second axis of rotation 6b, and the second primary pivot axis 1b is arranged between the second shaving track 11b and the first axis of rotation 6a. I.e. the first primary pivot axis 1a is positioned outwardly from the first shaving track 11a in a radial direction with respect to the first axis of rotation 6a, and consequently does not cross or cover any of the hair entry openings 13 of the external cutting member 12 of the first cutting unit 10a, seen in the direction of the first axis of rotation 6a. The same applies for the second primary pivot axis 1b relative to the second shaving track 11b and the second axis of rotation 6b. Furthermore, the primary pivot axes 1a, 1b each extend parallel to a plane wherein, respectively, the first and second shaving tracks 11a, 11b extend.

As will be described further in detail in the following, the central support member 50 comprises a stationary portion, which comprises the coupling member 70, and a movable portion. The first and second housings 20a, 20b of the cutting units 10a, 10b are pivotal about the first and second primary pivot axes 1a, 1b relative to the movable portion of the central support member 50. The movable portion of the central support member 50 is pivotal relative to the stationary portion of the central support member 50 about a secondary pivot axis 3 as indicated in FIGS. 1a-1c. In general, the secondary pivot axis 3 is not parallel to the first and second primary pivot axes 1a, 1b. In the embodiment shown in FIGS. 1a-1c, wherein the first and second primary pivot axes 1a, 1c coincide, the secondary pivot axis 3 extends perpendicularly to the coinciding first and second primary pivot axes 1a, 1b.

FIG. 1a shows the first and second cutting units 10a, 10b in a spring-biased neutral pivoted position, wherein the first cutting unit 10a is pivoted about the first primary pivot axis 1a in a clockwise direction into a maximum pivot angle, delimited by a mechanical stop not shown in the figures, and wherein the second cutting unit 10b is pivoted about the second primary pivot axis 1b in an anti-clockwise direction to a maximum pivot angle, which is also delimited by a mechanical stop not shown in the figures. These pivoted positions of the first and second cutting units 10a, 10b result in a concave V-shaped configuration of the first and second cutting units 10a, 10b and the first and second shaving tracks 11a, 11b.

FIG. 1b shows pivoted positions of the cutting units 10a, 10b, wherein the first and the second cutting units 10a, 10b are both pivoted about the primary pivot axes 1a, 1b in an anti-clockwise direction. In these pivoted positions of the cutting units 10a, 10b, the first and second shaving tracks 11a, 11b extend in a common plane shape which is oriented obliquely in relation to the main drive axis 9.

FIG. 1c shows pivoted positions of the cutting units 10a, 10b, wherein the first cutting unit 10a is pivoted about the first primary pivot axis 1a in an anti-clockwise direction, while the second cutting unit 10b is pivoted about the second primary pivot axis 1b in a clockwise direction. These pivoted positions of the cutting units 10a, 10b result in a convex V-shaped configuration of the first and second cutting units 10a, 10b and the first and second shaving tracks 11a, 11b. It is to be understood that the pivoted positions of the cutting units 10a, 10b shown in FIGS. 1a-1c are possible because the cutting units 10a, 10b are individually and mutually independently pivotal about the primary pivot axes 1a, 1b. I.e. the first cutting unit 10a can perform any pivotal motion about the first primary pivot axis 1a independently of any pivotal motion of the second cutting unit 10b about the second primary pivot axis 1b, and v.v.

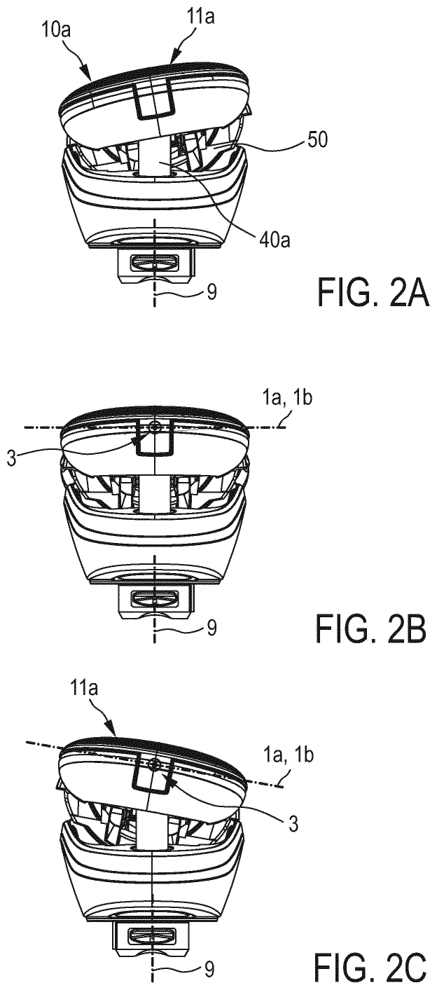

FIGS. 2a-2c show a side view of the first and second cutting units 10a, 10b in three different pivoted positions about the secondary pivot axis 3. In FIG. 2a the movable portion of the central support member 50, with the cutting units 10a, 10b connected thereto via the primary pivot axes 1a, 1b, is pivoted relative to the stationary portion of the central support member 50 in an anti-clockwise direction about the secondary pivot axis 3. FIG. 2b shows a neutral position of the movable portion with no pivoting of the cutting units 10a, 10b about the secondary pivot axis 3. FIG. 2c shows a third pivoted configuration wherein the movable portion of the central support member 50, with the cutting units 10a, 10b connected thereto via the primary pivot axes 1a, 1b, is pivoted relative to the stationary portion of the central support member 50 in a clockwise direction about the secondary pivot axis 3.

FIG. 3 shows a cross-sectional view of the shaving unit shown in FIGS. 1a-1c, and FIG. 4 shows a top view of said shaving unit with parts of the cutting units 10a, 10b being removed. As can be seen in these figures, both the coinciding primary pivot axes 1a, 1b and the secondary pivot axis 3 extend in a direction perpendicular to the main drive axis 9 in a non-pivoted position of the cutting units 10a, 10b about the primary pivot axes 1a, 1b and the secondary pivot axis 3.

As shown in FIG. 4, the first housing 20a of the first cutting unit 10a accommodates a first hair collecting chamber 27a, and the second housing 20b of the second cutting unit 10b accommodates a second hair collecting chamber 27b. The first and second hair collecting chambers 27a, 27b each have an annular shape. The first hair collecting chamber 27a surrounds a central opening 25a which is provided in a bottom wall 28a of the first housing 20a. Likewise, the second hair collecting chamber 27b surrounds a central opening 25b which is provided in a bottom wall 28b of the second housing 20b. As can be seen in FIG. 4, coupling elements 41a, 41b, which are provided on upper end portions of, respectively, the drive spindles 40a, 40b, extend through, respectively, the openings 25a, 25b. In the assembled condition of the cutting units 10a, 10b, the coupling elements 41a, 41b engage the internal cutting members of, respectively, the first cutting unit 10a and the second cutting unit 10b to transfer a rotational motion of the drive spindles 40a, 40b to the internal cutting members. It is to be understood that the internal cutting members and the external cutting members of the cutting units 10a, 10b are not shown in FIG. 4, while in FIG. 3 only the external cutting member 12 of the first cutting unit 10a is visible.

As shown in FIGS. 3 and 4, the coinciding first and second primary pivot axes 1a, 1b are defined by a first hinge structure, which mutually connects the first housing 20a and the second housing 20b, and by a second hinge structure, which connects an assembly of the mutually connected first and second housings 20a, 20b to the movable portion 51 of the central support member 50. FIG. 3 further shows the stationary portion 52 of the central support member 50. Said first and second hinge structures have coinciding hinge axes. The first hinge structure comprises cooperating first and second hinge elements 21a, 21b, which are connected to, respectively, the first housing 20a and the second housing 20b, and cooperating third and fourth hinge elements 22a, 22b, which are connected to, respectively, the first housing 20a and the second housing 20b. A bearing pin formed on the second hinge element 21b engages a bearing cavity formed in the first hinge element 21a, and a bearing pin formed on the third hinge element 22a engages a bearing cavity formed in the fourth hinge element 22b. The second hinge structure comprises two bearing pins 55 and 55′ which are integrally formed on the moveable portion 51 of the central support member 50. The two bearing pins 55 and 55′ are arranged coaxially and face each other. The bearing pin 55 engages a bearing cavity, which is formed in the second hinge element 21b and is arranged coaxially with the bearing pin formed on the second hinge element 21b. The bearing pin 55′ engages a bearing cavity, which is formed in the third hinge element 22a and is arranged coaxially with the bearing pin formed on the third hinge element 22a. The first and second hinge structures, comprising the hinge elements 21a, 21b, 22a, 22b formed on the housings 20a, 20b and the two bearing pins 55, 55′, formed on the movable portion 51 of the central support member 50, provide the coincident primary pivot axes 1a, 1b in a simple and robust manner. During assembly of the shaving unit, the hinge elements 21a, 21b and 22a, 22b can be simply snapped into each other thereby forming an assembly of the first and second housings 20a, 20b. Subsequently said assembly can be simply snapped in between the two bearing pins 55, 55′. Finally, as shown in FIG. 3, filling elements 24a, 24b may be arranged between, respectively, the hinge elements 21a, 22b and the movable portion 51 of the central support member 50 to fill the gaps which are required for assembling the first and second hinge structures. The filling elements 24a, 24b prevent unintentional disassembling of the first and second hinge structures during use of the shaving unit.

The bearing pins 55, 55′define the position of the coinciding primary pivot axes 1a, 1b relative to the housings 20a, 20b. The bearing pins 55, 55′ are arranged between the housings 20a, 20b, seen in directions parallel to the axes of rotation 6a, 6b of the cutting units 10a, 10b as e.g. in FIG. 4. As can further be seen in FIGS. 1a and 1b, seen in a direction parallel to the secondary pivot axis 3, in the neutral pivoted position of the first cutting unit 10a (FIG. 1a) the first primary pivot axis 1a is arranged between a skin contact surface of the first shaving track 11a and a bottom of the first housing 20a. Similarly, seen in a direction parallel to the secondary pivot axis 3, in the neutral pivoted position of the second cutting unit 10b (FIG. 1b) the second primary pivot axis 1b is arranged between a skin contact surface of the second shaving track 11b and a bottom of the second housing 20b. The first and second housings 20a, 20b each have an identical height H, seen in respective directions parallel to the first axis of rotation 6a and parallel to the second axis of rotation 6b. In an intermediate pivoted position of the cutting units 10a, 10b between the pivoted positions as shown in FIGS. 1a and 1c, wherein the first and second shaving tracks 11a, 11b extend in a common plane, a distance D between the first primary pivot axis 1a and the skin contact surface of the first shaving track 11a, in particular measured in a central imaginary plane comprising the first primary pivot axis 1a and the central drive axis 9, is smaller than 50% of the height H. Likewise, in said intermediate pivoted position of the cutting units 10a, 10b, a distance D′ between the second primary pivot axis 1b and the skin contact surface of the second shaving track 11b, in particular measured in a central imaginary plane comprising the second primary pivot axis 1b and the central drive axis 9, is smaller than 50% of the height H.

The movable portion 51 of the central support member 50 is pivotally guided along a curved path 57 relative to the stationary portion 52 of the central support member 50. Seen in the cross-sectional view of the shaving unit in FIG. 3, the curved path 57 comprises a circle segment having a radius and a center point, which defines the position of the secondary pivot axis 3 as a virtual axis. The secondary pivot axis 3 extends perpendicularly to the coinciding primary pivot axes 1a, 1b and lies approximately in a common plane with the coinciding primary pivot axes 1a, 1b. Said common plane extends approximately parallel to the skin contact surfaces of the first shaving track 11a and the second shaving track 11b in an intermediate pivoted position of the cutting units 10a, 10b between the pivoted positions as shown in FIGS. 1a and 1c, wherein the first and second shaving tracks 11a, 11b extend in a common plane. As a result, in said intermediate pivoted position of the cutting units 10a, 10b, a distance D″ between the secondary pivot axis 3 and the skin contact surfaces of the first and second shaving tracks 11a, 11b, in particular measured in a central imaginary plane comprising the secondary pivot axis 3 and the central drive axis 9, is equal to the distances D, D′ between the coinciding primary pivot axes 1a, 1b and the skin contact surfaces of the first and second shaving tracks 11a, 11b as shown in FIG. 1b, i.e. said distance D″ is smaller than 50% of the height H of the housings 20a, 20b of the cutting units 10a, 10b. It will be clear that, in embodiments wherein the secondary pivot axis 3 and the primary pivot axes 1a, 1b do not extend in a common plane, the distance D″ may be different from the distances D, D′.

As can be further seen in FIG. 3, two spring elements 23a, 23b are arranged below the coinciding primary pivot axes 1a, 1b in the movable portion 51 of the central support member 50. The spring elements 23a, 23b exert a spring load on the housings 20a, 20b of the cutting units 10a, 10b such as to bias the cutting units 10a, 10b in their concave pivoted positions as shown in FIG. 1a, wherein the skin contact surfaces of the shaving tracks 11a, 11b have a V-shaped geometry. It is to be understood that, in variations of the embodiment of the shaving unit, the spring elements may bias the cutting units 10a, 10b into different pivoted positions, e.g. into pivoted positions wherein the skin contact surfaces of the shaving tracks 11a, 11b extend in a common plane and, thus, have a flat geometry, or into pivoted positions wherein the skin contact surfaces of the shaving tracks 11a, 11b have a convex geometry.

Furthermore, the assembly of the cutting units 10a, 10b is biased into a neutral pivoted position relative to the secondary pivot axis 3 by a further spring element 23c. The further spring element 23c is arranged in the stationary portion 52 of the central support member 50 and exerts a biasing force on the movable portion 51 of the central support member 50. Starting from the neutral pivoted position relative to the secondary pivot axis 3 as shown in FIG. 3, the assembly of the cutting units 10a, 10b may conduct a pivotal movement in a clockwise direction or in an anti-clockwise direction about the secondary pivot axis 3.

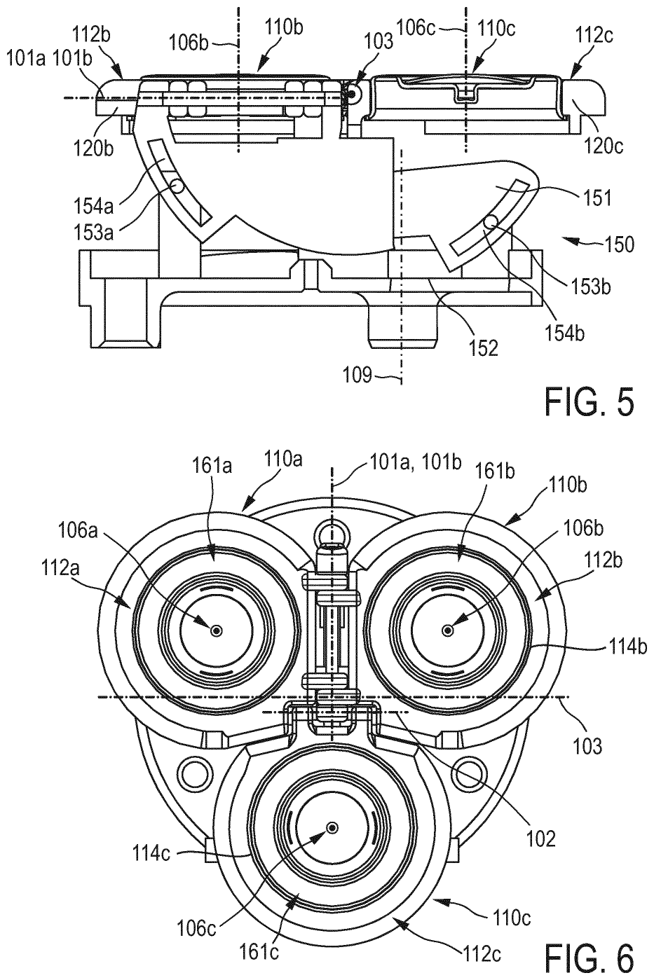

FIGS. 5-8 show a shaving unit according to a second embodiment of the invention. This shaving unit comprises three cutting units, i.e. a first cutting unit 110a, a second cutting unit 110b, and a third cutting unit 110c. Each of the three cutting units 110a, 110b, 110c comprises a housing 120a, 120b, 120c, an external cutting member 114a, 114b, 114c with a plurality of hair entry openings which define an annular shaving track 161a, 161b, 161c, and an internal cutting member (not shown in detail in the figures) which is rotatable relative to the external cutting member 114a, 114b, 114c about an axis of rotation 106a, 106b, 106c and which is arranged in the housing 120a, 120b, 120c. The annular shaving tracks 161a, 161b, 161c each have a skin contact surface. The external cutting members 114a, 114b, 114c are each arranged in and held by an annular cover portion 112a, 112b, 112c of, respectively, the housings 120a, 120b, 120c. Each of the cover portions 112a, 112b, 112c also has a skin contact surface surrounding the skin contact surface of the associated shaving track 161a, 161b, 161c. The housings 120a, 120b, 120c each accommodate a hair collecting chamber.

The first cutting unit 110a and the second cutting unit 110b are pivotal relative to a central support member 150 of the shaving unit about, respectively, a first primary pivot axis 101a and a second primary pivot axis 101b. Like the first and second primary pivot axes 1a, 1b in the embodiment of the shaving unit shown in FIGS. 1-4, the first and second primary pivot axes 101a, 101b are arranged as coinciding first and second primary pivot axes. By means of the first and second primary pivot axes 101a, 101b, the first and second cutting units 110a, 110b are pivotal relative to a movable portion 151 of the central support member 150. The coincident first and second primary pivot axes 101a, 101b are realized by similar hinge structures used to realize the coinciding first and second primary pivot axes 1a, 1b in the embodiment of FIGS. 3-4.

The third cutting unit 110c is pivotal relative to the central support member 150 about a third primary pivot axis 102, which extends perpendicularly to the coinciding first and second pivot axes 101a, 101b. Seen in a direction parallel to the axis of rotation 106c of the third cutting unit 110c, the third primary pivot axis 102 is arranged between the shaving track 161c of the third cutting unit 110c and the axes of rotation 106a, 106b of the first and second cutting units 110a, 110b, as is shown in FIG. 6. Seen in the direction parallel to the axis of rotation 106c of the third cutting unit 110c, the third primary pivot axis 102 is in particular arranged between the external cutting member 114c of the third cutting unit 110c and the axes of rotation 106a, 106b of the first and second cutting units 110a, 110b. However, in alternative embodiments, the third primary pivot axis 102 may be arranged in a position which is not or not fully between the external cutting member 114c of the third cutting unit 110c and the axes of rotation 106a, 106b of the first and second cutting units 110a, 110b, e.g. in a position wherein the third primary pivot axis 102 crosses the external cutting member 114c of the third cutting unit 110c in a circumferential area thereof. In such alternative embodiments, the third primary pivot axis 102 may still be arranged between the shaving track 161c of the third cutting unit 110c and the axes of rotation 106a, 106b of the first and second cutting units 110a, 110b, i.e. arranged outwardly from the shaving track 161c of the third cutting unit 110c in a radial direction with respect to the axis of rotation 106c of the third cutting unit 110c and, consequently, not crossing or covering any of the hair entry openings of the external cutting member 114c of the third cutting unit 110c, seen in the direction of the axis of rotation 106c of the third cutting unit 110c.

In the embodiment of the shaving unit shown in FIGS. 5-8, the housing 120c of the third cutting unit 110c is pivotally mounted to both the housing 120a of the first cutting unit 110a and the housing 120b of the second cutting unit 110b. Thus, the third primary pivot axis 102, about which the third cutting unit 110c is pivotal relative to the central support member 150, is a pivot axis about which the third cutting unit 110c is pivotal relative to both the central support member 150 and the first and second cutting units 110a, 110b. The third primary pivot axis 102 is realized by means of a first hinge structure, by means of which the housing 120c of the third cutting unit 110c is connected to the housing 120a of the first cutting unit 110a, and by means of a second hinge structure, by means of which the housing 120c of the third cutting unit 110c is connected to the housing 120b of the second cutting unit 110b. As shown in detail in FIG. 8, said first hinge structure comprises a bearing pin 126a, mounted in a fixed position to the housing 120a of the first cutting unit 110a, and a bearing bush 127a mounted in a fixed position to the housing 120c of the third cutting unit 110c. Likewise, said second hinge structure comprises a bearing pin 126b, mounted in a fixed position to the housing 120b of the second cutting unit 110b, and a bearing bush 127b mounted in a fixed position to the housing 120c of the third cutting unit 110c. The bearing pins 126a, 126b engage and are received by, respectively, the bearing bushes 127a, 127b. The bearing bushes 127a, 127b are coaxially arranged on the housing 120c of the third cutting unit 110c and, thereby, define the position of the third primary pivot axis 102 relative to the housing 120c of the third cutting unit 110c. As shown in FIG. 8, seen in a longitudinal sectional view along the third primary pivot axis 102, the bearing bushes 127a, 127b each have a non-cylindrical, in particular a convex internal bearing surface which is in contact with the associated bearing pin 126a, 126. In other words, the internal bearing surfaces of the bearing bushes 127a, 127b have a beveled shape towards both their ends, i.e. said internal bearing surfaces have a shape like an hour glass. As a result, the bearing pin 126a and the bearing bush 127a of the first hinge structure can mutually rotate about an axis parallel to the first primary pivot axis 1a. Likewise, the bearing pin 126b and the bearing bush 127b of the second hinge structure can mutually rotate about an axis parallel to the second primary pivot axis 1b. As a result, the first and second hinge structures are adapted to independently follow both a pivotal movement of the housing 120a of the first cutting unit 110a about the first primary pivot axis 101a and a pivotal movement of the housing 120b of the second cutting unit 110b about the second primary pivot axis 101b. Thus, the third cutting unit 110c is free to pivot about the third primary pivot axis 102 in any pivotal position of the first and second cutting units 110a, 110b about the first and second primary pivot axes 101a, 101b.

As shown in FIGS. 5 and 8, the central support member 150 is arranged below the cutting units 110a, 110b, 110c and comprises the moveable portion 151 and a stationary portion 152. The stationary portion 152 comprises a coupling member 170 by means of which the shaving unit can be releasably coupled to a main housing of a shaving apparatus. The movable portion 151 is pivotal relative to the stationary portion 152 about a secondary pivot axis 103, which extends perpendicularly to the coinciding first and second primary pivot axes 101a, 101b and parallel to the third primary pivot axis 102, as shown in FIG. 6. The secondary pivot axis 103 is realized by means of a connecting-link-guidance mechanism comprising at least one connecting member guided along a corresponding curved guidance path. In the embodiment shown in FIGS. 5-8, the connecting-link-guidance mechanism comprises a plurality of connecting members in the form of connecting pins 153a, 153b, 153c mounted in fixed positions to the stationary portion 152 of the central support member 150. The connecting pins 153a, 153b, 153c are each guided in a respective curved guidance slot 154a, 154b, 154c provided in a fixed position in the movable section 151 of the central support member 150. The curved guidance slots 154a, 154b, 154c each have a similar radius and coinciding center axes, which form a virtual axis defining the secondary pivot axis 103. By means of said connecting-link-guidance mechanism, the movable portion 151 of the central support member 150, carrying the three cutting units 110a, 110b, 110c, is pivotal relative to the stationary portion 152 of the central support member 150 about the secondary pivot axis 103.

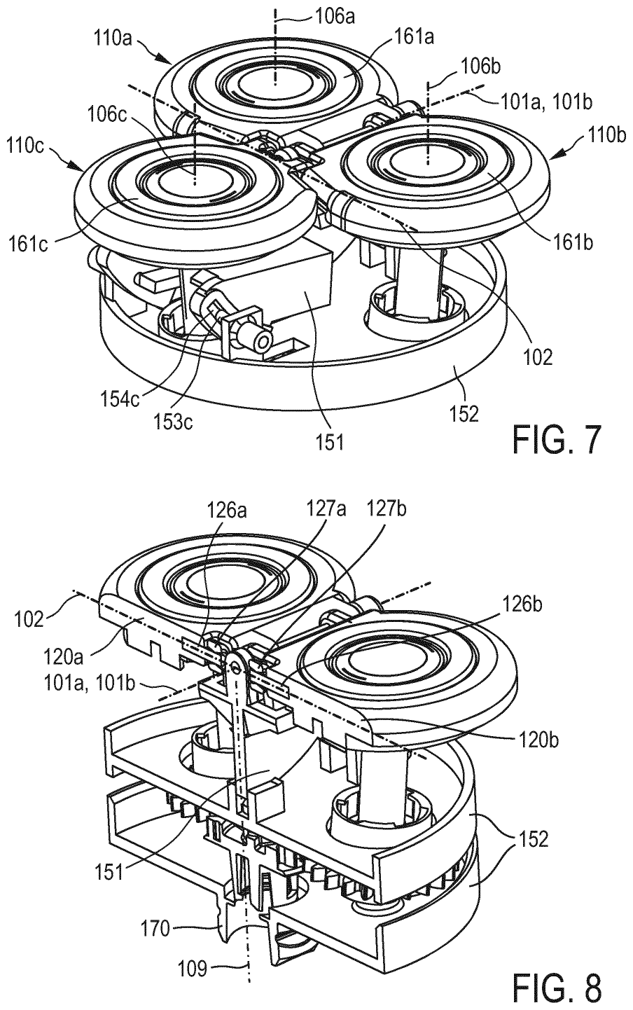

Furthermore, in the embodiment shown in FIGS. 5-8, the coinciding first and second primary pivot axes 101a, 101b, the third primary pivot axis 102 and the secondary pivot axis 103 each extend parallel to a common plane, in which the skin contact surfaces of the shaving tracks 161a, 161b, 161c of the cutting units 110a, 110b, 110c extend when the cutting units 110a, 110b, 110c are in intermediate pivotal positions, as shown in FIG. 7, wherein the skin contact surfaces of the shaving tracks 161a, 161b, 161c each extend perpendicularly to a central axis 109 of the shaving unit and wherein the axes of rotation 106a, 10b, 106c of the cutting units 110a, 110b, 110c are mutually parallel. As a result of the presence of the first and second primary pivot axes 101a, 101b, the third primary pivot axis 103, and the secondary pivot axis 103, a twofold pivotal motion is provided for each cutting unit 110a, 110b, 110c, wherein the three cutting units 110a, 110b, 110c can perform a common pivotal movement about the secondary pivot axis 103 and wherein each cutting unit 110a, 110b, 110c can further perform an individual and independent pivotal movement about, respectively, the first, second and third primary pivot axis 101a, 101b, 102.

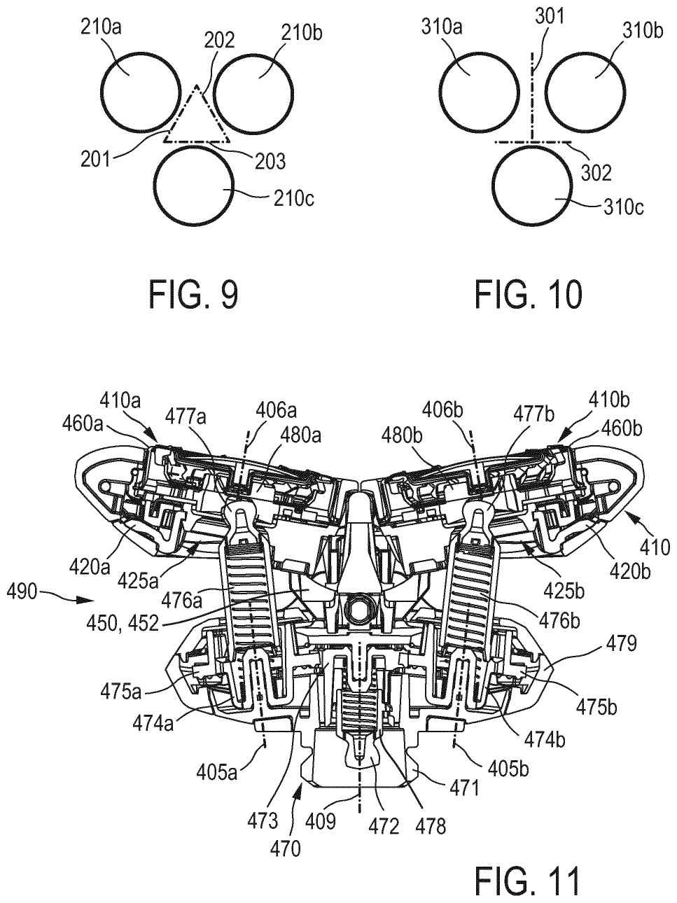

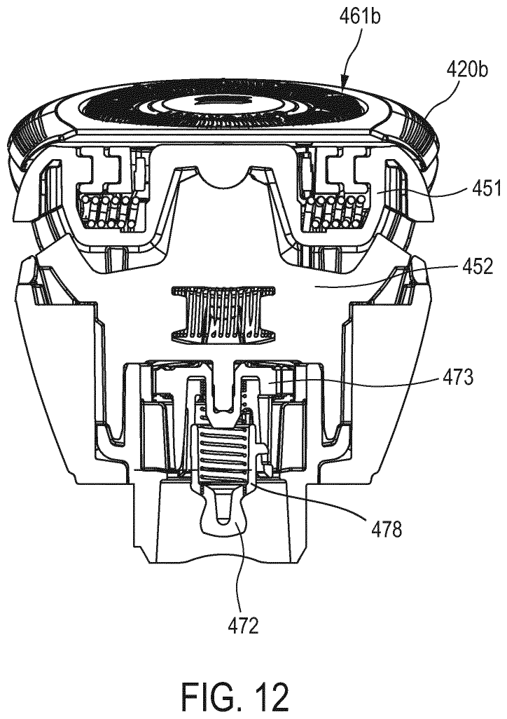

FIG. 9 shows a schematic view of a third embodiment of a shaving unit according to the invention having three cutting units 210a, 210b, 210c and three primary pivot axes 201, 202, 203, i.e. a first primary pivot axis 201 for the first cutting unit 210a, a second primary pivot axis 202 for the second cutting unit 210b and a third primary pivot axis 203 for the third cutting unit 210c Like the primary pivot axis 1a, 1b; 101a, 101b, 102 in the first and second embodiments, the primary pivot axes 201, 202, 203 each constitute a pivot axis about which the cutting units 210a, 210b, 210c are respectively pivotal relative to a central support member of the shaving unit, which is not shown in FIG. 9. In this embodiment, the three primary pivot axes 201, 202, 203 are arranged in a triangular configuration. The first primary pivot axis 201 is arranged between a shaving track (not shown) of the first cutting unit 210a and the axes of rotation of the internal cutting members (not shown) of the second and third cutting units 210b, 210c. Likewise, the second primary pivot axis 202 is arranged between a shaving track (not shown) of the second cutting unit 210b and the axes of rotation of the internal cutting members (not shown) of the first and third cutting units 210a, 210c, and the third primary pivot axis 203 is arranged between a shaving track (not shown) of the third cutting unit 210c and the axes of rotation of the internal cutting members (not shown) of the first and second cutting units 210a, 210b.

FIG. 10 shows a schematic view of a fourth embodiment of a shaving unit according to the invention, having three cutting units 310a, 310b, 310c and having primary pivot axes 301 and 302. In this embodiment, the arrangement of the primary pivot axes 301, 302 is similar to the arrangement of the primary pivot axes 101a, 101b, 102 in the second embodiment explained beforehand. The first and second cutting units 310a, 310b have a common primary pivot axis 301, i.e. they have coinciding primary pivot axes about which the cutting units 310a, 310b can each individually and independently pivot relative to a central support member (not shown) of the shaving unit. The third cutting unit 310c has a primary pivot axis 302 about which the third cutting unit 310c can pivot relative to the central support member. The primary pivot axis 302 extends perpendicularly to the common primary pivot axis 301 of the first and second cutting units 310a, 310b. The common primary pivot axis 301 and the primary pivot axis 302 constitute, respectively, a leg and a crossbar of a T-shaped configuration of the primary pivot axes 301, 302.

FIG. 11 shows a sectional frontal view of the shaving unit of FIGS. 1-4 and shows a drive train for the first and second cutting units 410a, 410b of the shaving unit. The shaving unit as shown in FIG. 11 comprises a coupling member 470 at a bottom side of the shaving unit, by means of which the shaving unit can be releasably coupled to a main housing of a shaving apparatus. At its outer circumference the coupling member 470 comprises a stationary coupling component 471 for releasably mounting the shaving unit to the main housing, i.e. a handle section, of the shaving apparatus. Inside the coupling member 470, a rotatable coupling component 472 is accommodated. The rotatable coupling component 472 is mounted to an end portion of a central drive shaft 478 accommodated in the coupling member 470. The rotatable coupling component 472 is adapted to be coupled to a drive shaft of a drive unit incorporated in said handle section of the shaving apparatus for torque transmission from the drive shaft in the handle section to the central drive shaft 478, when the shaving unit is coupled to the handle section.

The rotatable coupling component 472 and the central drive shaft 478 are parts of the drive train of the shaving unit. The central drive shaft 478 is connected to a central transmission element, embodied as a central gear wheel 473. Said central gear wheel 473 is rotatable about a central transmission axis 409, which corresponds to the main drive axis 9 described beforehand with reference to the embodiment shown in FIGS. 1-4. During operation, with the shaving unit coupled to the handle section of the shaving apparatus, the central gear wheel 473 is driven into rotation about the central transmission axis 409 by the drive unit of the handle section via the rotatable coupling component 472 and the central drive shaft 478.

A first driven transmission element and a second driven transmission element, embodied as, respectively, a first driven gear wheel 475a and a second driven gear wheel 475b, are arranged to be driven by the central gear wheel 473. The first and second driven gear wheels 475a, 475b are positioned adjacent to and on opposite sides of the central gear wheel 473 and each engage the central gear wheel 473 for torque transmission. The first driven gear wheel 475a and the second driven gear wheel 475b are positioned, relative to the central transmission axis 409, radially outwardly from the central gear wheel 473, and are each arranged in a slightly oblique orientation with respect to the central transmission axis 409. Thus, the first driven gear wheel 475a is rotatable about a first transmission axis 405a, which has a slightly oblique orientation with respect to the central transmission axis 409. Likewise, the second driven gear wheel 475b is rotatable about a second transmission axis 405b, which also has a slightly oblique orientation with respect to the central transmission axis 409. The first and second transmission axes 405a, 405b are symmetrically arranged with respect to the central transmission axis 409.

The first and second transmission axes 405a, 405b and the central transmission axis 409 are each arranged in a stationary position relative to the coupling member 470 and relative to the stationary portion 452 of the central support member 450 of the shaving unit. The central gear wheel 473 and the first and second driven gear wheels 475a, 475b are accommodated in a transmission housing 479, which is also arranged in a stationary position relative to the coupling member 470 and relative to the stationary portion 452 of the central support member 450 of the shaving unit. The central gear wheel 473 and the first and second driven gear wheels 475a, 475b are arranged as a transmission unit, accommodated in the transmission housing 479, between the coupling member 470 and the first and second cutting units 410a, 410b. Between the transmission housing 479 and the first and second cutting units 410a, 410b, an open space 490 is present which surrounds the central support member 450 as shown in FIG. 11. The open space 490 between the transmission housing 479 and the first and second cutting units 410a, 410 is generally open and, thereby, accessible from any radial direction with respect to the central transmission axis 409. The transmission housing 479 is thus arranged between the coupling member 470 and the open space 490.

The internal cutting member 480a of the first cutting unit 410a is connected to the first driven gear wheel 475a by means of a first drive spindle 476a, and the internal cutting member 480b of the second cutting unit 410b is connected to the second driven gear wheel 475b by means of a second drive spindle 476b. The first drive spindle 476a extends from the transmission unit in the transmission housing 479 to the internal cutting member 480a of the first cutting unit 410a via the open space 490 and through the opening 425a in the bottom wall of the housing 420a of the first cutting unit 410a. Likewise, the second drive spindle 476b extends from the transmission unit in the transmission housing 479 to the internal cutting member 480b of the second cutting unit 410b via the open space 490 and through the opening 425b in the bottom wall of the housing 420b of the second cutting unit 410. The openings 425a, 425b in the bottom walls of the housings 420a, 420b of the first and second cutting units 410a, 410b shown in FIG. 11 correspond to the openings 25a, 25b in the bottom walls of the housings 20a, 20b of the first and second cutting units shown in FIG. 4.

The first and second driven gear wheels 475a, 475b are circumferentially provided and integrally formed on, respectively, a first cup-shaped rotatable carrier 474a and a second cup-shaped rotatable carrier 474b. A lower end portion of the first drive spindle 476a engages the first rotatable carrier 474a, and a lower end portion of the second drive spindle 476b engages the second rotatable carrier 474b. The lower end portions of the first and second drive spindles 476a, 476b are configured in such a manner that the drive spindles 476a, 476b can slide in the two opposite directions parallel to, respectively, the first transmission axis 405a and the second transmission axes 405b inside, respectively, the first cup-shaped rotatable carrier 474a and the second cup-shaped rotatable carrier 474b. A mechanical spring is arranged in each of the first and second drive spindles 476a, 476b, as shown in FIG. 11. The first drive spindle 476a is displaceable towards the first driven gear wheel 475a against a spring force of the associated mechanical spring in a direction parallel to a spindle axis of the first drive spindle 476a, which generally extends substantially or nearly parallel to the first transmission axis 405a. Likewise, the second drive spindle 476b is displaceable towards the second driven gear wheel 475b against a spring force of the associated mechanical spring in a direction parallel to a spindle axis of the second drive spindle 476b, which generally extends substantially or nearly parallel to the second transmission axis 405b.

Furthermore, the lower end portions of the first and second drive spindles 476a, 476b are configured in such a manner that the drive spindles 476a, 476b can pivot relative to, respectively, the first driven gear wheel 475a and the second driven gear wheel 475b to a limited extent about any axis perpendicular to, respectively, the first transmission axis 405a and the second transmission axes 405b. Finally, the lower end portions of the first and second drive spindles 476a, 476b are configured in such a manner that the first and second cup-shaped rotatable carriers 474a, 474b can transmit a driving torque to, respectively, the first drive spindle 476a and the second spindle 476b by engagement with the lower end portions thereof.

As further shown in FIG. 11, coupling elements 477a, 477b are provided on an upper end portion of, respectively, the first drive spindle 476a and the second drive spindle 476b. The coupling elements 477a, 477b couple the first and second drive spindles 476a, 476b with, respectively, the internal cutting member 480a of the first cutting unit 410a and the internal cutting member 480b of the second cutting unit 410b. The coupling elements 477a, 477b are configured in such a manner that the first and second drive spindles 476a, 476b can transmit a driving torque to, respectively, the internal cutting member 480a of the first cutting unit 410a and the internal cutting member 480b of the second cutting unit 410b. Thus, the first and second drive spindles 476a, 476b are able to transmit a rotational movement from the first and second driven gear wheels 475a, 475b via the coupling elements 477a, 477b to the internal cutting members 480a, 480b of the first and second cutting units 410a, 410b, respectively. Furthermore, the coupling elements 477a, 477b are configured in such a manner that the first and second drive spindles 476a, 476b can pivot to a limited extent relative to, respectively, the internal cutting member 480a of the first cutting unit 410a and the internal cutting member 480b of the second cutting unit 410b about any axis perpendicular to, respectively, the first transmission axis 405a and the second transmission axes 405b. This can e.g. be achieved by a triangular cross-sectional geometry of the coupling elements 477a, 477b and by providing each internal cutting member 480a, 480b with a coupling cavity having a corresponding geometry for receiving the associated coupling element 477a, 477b, as is well known to the person skilled in the art. It is to be understood that the coupling elements 477a, 477b correspond with the coupling elements 41a, 41b of the shaving unit shown in FIG. 4.

During operation, the internal cutting members 480a, 480b of the first and second cutting units 410a, 410b are driven into a rotational movement about the first and second axes of rotation 406a, 406b relative to the external cutting members 460a, 460b of the first and second cutting units 410a, 410b by the first and second drive spindles 476a, 476b, respectively. As described here before, the first and second drive spindles 476a, 476b are displaceable against a spring force in directions parallel to their spindle axes relative to, respectively, the first and second driven gear wheels 475a, 475b. Furthermore, as described here before, the first and second drive spindles 476a, 476b are pivotally arranged relative to, respectively, the first and second driven gear wheels 475a, 475b and relative to the internal cutting member 480a, 480b of, respectively, the first and second cutting units 410a. As a result, the first and second drive spindles 476a, 476b can follow pivotal movements of the first and second cutting units 410a, 410b about their primary pivot axis 1a, 1b as described with respect to the embodiment of the shaving unit of FIGS. 1-4. The mechanical springs arranged in the drive spindles 476a, 476b bias the drive spindles 476a, 476b towards the internal cutting members 480a, 480b and thus maintain a permanent contact and engagement between the coupling elements 477a, 477b and the internal cutting members 480a, 480b in any pivotal position of the first and second cutting units 410a, 410b about the primary pivot axes 1a, 1b and in any angular orientation of the first and second axis of rotation 406a, 406b relative to, respectively, the first and second transmission axis 405a, 405b.

In the embodiment of the shaving unit shown in FIGS. 1-4 and in FIG. 11, the spindle axes of the first and second drive spindles 476a, 476b and the secondary pivot axis 3 extend in a common imaginary plane, as can best be seen in FIG. 4. As a result, during pivotal movements of the first and second cutting units 410a, 410b about the secondary pivot axis 3, the drive spindles 476a, 476b will remain in said common imaginary plane and their positions in said common imaginary plane do not substantially change. This will particularly be the case when the secondary pivot axis 3 extends through the coupling elements 477a, 477b of the drive spindles 476a, 476b. In alternative embodiments wherein the spindle axes of the first and second drive spindles 476a, 476b and the secondary pivot axis 3 do not extend in a common imaginary plane, the layout of the drive spindles 476a, 476b and the coupling elements 477a, 477b as described here before will allow the drive spindles 476a, 476b to also follow pivotal movements of the first and second cutting units 410a, 410b about the secondary pivot axis 3 as described with respect to the embodiment of the shaving unit of FIGS. 1-4, as well as combined pivotal movements of the first and second cutting units 410a, 410b about both their primary pivot axes 1a, 1b and the secondary pivot axis 3.

It is to be understood that, in embodiments of a shaving unit comprising three cutting units as e.g. shown in FIGS. 5-8, the internal cutting member of the third cutting unit may be connected to the transmission unit by means of a third drive spindle extending from the transmission unit to said internal cutting member via the open space and through an opening in a bottom wall of the housing of the third cutting unit. In such embodiments, the third drive spindle may have a similar layout as the first and second drive spindles 476a, 476b in the embodiment of the shaving unit shown in FIG. 11. It will be clear that, in such embodiments, the transmission unit may comprise a third driven transmission element, e.g. a third driven gear wheel, arranged to be driven by the central gear wheel of the transmission unit in a manner similar to the first and second driven gear wheels 475a, 475b in the embodiment of the shaving unit shown in FIG. 11. In such embodiments, the internal cutting member of the third cutting unit is connected to said third driven gear wheel via the third drive spindle.

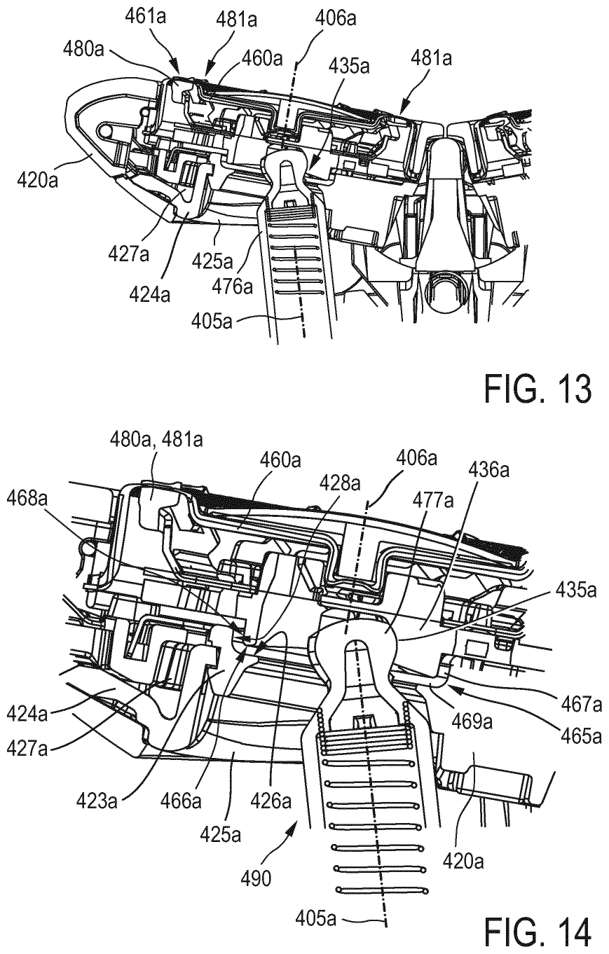

FIGS. 13 and 14 are detailed views of the first cutting unit 410a of the shaving unit of FIG. 11. In the following, further structural elements of the first cutting unit 410a of the shaving unit of FIG. 11 will be described with reference to FIGS. 13 and 14. It is to be understood that the second cutting unit 410b of the shaving unit of FIG. 11 has similar structural elements. It is further to be understood that also the cutting units of the embodiment of the shaving unit shown in FIGS. 5-10 may have similar structural elements.

FIGS. 13 and 14 show the internal cutting member 480a in a position in the housing 420a below the external cutting member 460a. The external cutting member 460a has a plurality of hair entry openings which define the shaving track 461a along which, during operation, hair-cutting actions will take place by interaction between the external cutting member 460a and the internal cutting member 480a rotating relative to the external cutting member 460a about the axis of rotation 406a. Any cut hairs will be received by and collected in the hair collecting chamber 427a which is accommodated in the housing 420a. FIGS. 13 and 14 further show in detail the first drive spindle 476a which extends through the opening 425a provided in the bottom wall 424a of the housing 420a. The opening 425a is provided centrally around the axis of rotation 406a. The hair collecting chamber 427a is annularly arranged around the opening 425a and around the axis of rotation 406a. The coupling element 477a of the first drive spindle 476a engages a coupling cavity 435a, which is centrally provided in a central carrying member 436a of the internal cutting member 480a. The central carrying member 436a carries a plurality of cutting elements 481a of the internal cutting member 480a.

The opening 425a is in fluid communication with the hair collecting chamber 427a. As a result, the hair collecting chamber 427a can be cleaned by providing a flow of a cleaning liquid, e.g. water, via the opening 425a into the hair collecting chamber 427a. Such a flow of e.g. water can be easily provided to the opening 425a via the open space 490 which is present between the transmission housing 479 and the cutting units 410a, 410b. To prevent cut hairs and other shaving debris from escaping from the hair collecting chamber 427a via the opening 425a into the open space 490 during normal use of the shaving unit, a sealing structure 465a is provided in the flow path between the opening 425a and the hair collecting chamber 427a. The sealing structure 465a is configured and arranged to prevent cut hairs from escaping from the hair collecting chamber 427a via the opening 425a, but to allow a cleaning liquid, in particular water, to flow or flush via the opening 425a into the hair collecting chamber 427a. An embodiment of the sealing structure 465a will be described in the following. It is to be understood that the second cutting unit 410b has a similar sealing structure.

As shown in detail in FIG. 14, the sealing structure 465a comprises opposed sealing surfaces 426a, 428a and 466a, 468a. The sealing surfaces 426a, 428a are provided on the housing 420a, in particular on an edge structure 423a which is provided in the bottom wall 424a around the opening 425a. The sealing surfaces 466a, 468a are provided on the internal cutting member 480a, in particular on the central carrying member 436a of the internal cutting member 480a. The opposed sealing surfaces 426a, 428a and 466a, 468a are rotationally symmetrical relative to the axis of rotation 406a. As a result, the sealing structure 465a is rotationally symmetrical relative to the axis of rotation 406a.

In particular, the sealing structure 465a comprises a first sealing gap 467a, which is rotationally symmetrical relative to the axis of rotation 406a and has a main direction of extension parallel to the axis of rotation 406a. The first sealing gap 467a is bounded by a first sealing surface 468a of said opposed sealing surfaces, which is provided on the central carrying member 436a of the internal cutting member 480a, and by a second sealing surface 428a of said opposed sealing surfaces, which is provided on the edge structure 423a in the bottom wall 424a of the housing 420a. The first and second sealing surfaces 468a, 428a are each rotationally symmetrical relative to the axis of rotation 406a and each have a main direction of extension parallel to the axis of rotation 406a. In particular, the first and second sealing surfaces 468a, 428a and the first sealing gap 467a, bounded by the first and second sealing surfaces 468a, 428a, are each annular.

Further, the sealing structure 465a comprises a second sealing gap 469a, which is rotationally symmetrical relative to the axis of rotation 406a and has a main direction of extension perpendicular to the axis of rotation 406a. The second sealing gap 469a is bounded by a third sealing surface 466a of said opposed sealing surfaces, which is provided on the central carrying member 436a of the internal cutting member 480a, and by a fourth sealing surface 426a of said opposed sealing surfaces, which is provided on the edge structure 423a in the bottom wall 424a of the housing 420a. The third and fourth sealing surfaces 466a, 426a are each rotationally symmetrical relative to the axis of rotation 406a and each have a main direction of extension perpendicular to the axis of rotation 406a. In particular, the third and fourth sealing surfaces 466a, 426a and the second sealing gap 469a, bounded by the third and fourth sealing surfaces 466a, 426a, are each annular.

Seen in a cross-sectional view along the axis of rotation 406a, the axially oriented first sealing gap 467a and the radially oriented second sealing gap 469a together provide the sealing structure 465a with an L-shaped gap structure provided between the edge structure 423a and the central carrying member 436a, which is rotatable relative to the edge structure 423a about the axis of rotation 406a. In order to achieve an effective preventing of cut hairs from escaping from the hair collecting chamber 427a via the sealing structure 465a during a shaving procedure, while allowing an effective flow of water from the opening 425a via the sealing structure 465a into the hair collecting chamber 427a, a minimum distance between the first sealing surface 468a and the second sealing surface 428a, measured in a direction perpendicular to the axis of rotation 406a, is preferably in a range between 0.1 mm and 1.5 mm. For similar reasons, a minimum distance between the third sealing surface 466a and the fourth sealing surface 426a, measured in a direction parallel to the axis of rotation 406a, is preferably in a range between 0.1 mm and 1.5 mm. To further improve the sealing function of the sealing structure 465a, the first and second sealing gaps 467a, 469a may each converge, seen in a direction of the water flow from the central opening 425a to the hair collecting chamber 427a.

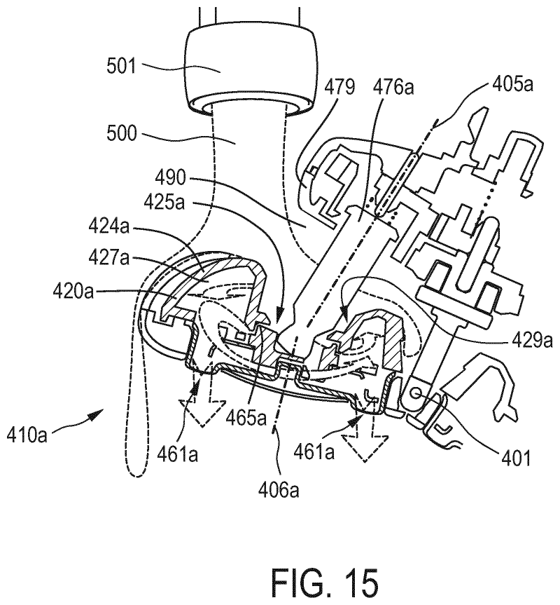

FIG. 15 shows a flushing procedure to clean the hair collecting chamber 427a of the first cutting unit 410a. In FIG. 15 the shaving unit is shown in an upside-down position to facilitate a flow of water via the open space 490 into the opening 425a in the bottom wall 424a of the housing 420a. As illustrated in FIG. 15, in said upside-down position of the shaving unit the open space 490 allows a flow of water 500, e.g. from a water tap 501, to directly enter the cutting unit 410a via the opening 425a. This can be simply realized by directing a stream of water 500 from the tap 501 via the open space 490 onto the bottom wall 424a of the cutting unit 410a. The flushing water is directed into the opening 425a by a funnel 429a, provided in the bottom wall 424a of the housing 420a, and passes into the hair collecting chamber 427a via the L-shaped sealing structure 465a, which is provided in the flow path between the opening 425a and the hair collecting chamber 427a. As indicated in FIG. 15 by broken arrows which show the flow of water through the cutting unit 410a, the hair collecting chamber 427a is flushed by the flow of water. Under the influence of both the gravity force and the hydraulic pressure of the flow of water, the flow of water is forced to leave the hair collecting chamber 427a via the plurality of hair entry openings provided in the shaving track 461a of the external cutting member 460a. This is indicated by two broken arrows pointing in downward direction in FIG. 15. The flow of water will take up and carry cut hairs and other shaving debris collected in the collecting chamber 427a. As a result, the cut hairs and other shaving debris are removed from the hair collecting chamber 427a by the flow of water leaving the hair collecting chamber 427a via the hair entry openings in the shaving track 461a. Thus, the hair collecting chamber 427a can be cleaned in a simple and efficient way by flushing the cutting unit 410a by means of a flow of water supplied via the open space 490 and via the opening 425a into the hair collecting chamber 427a. It is clear for the skilled person that the second cutting unit 410b can be cleaned in a similar way, preferably together with the first cutting unit 410a.

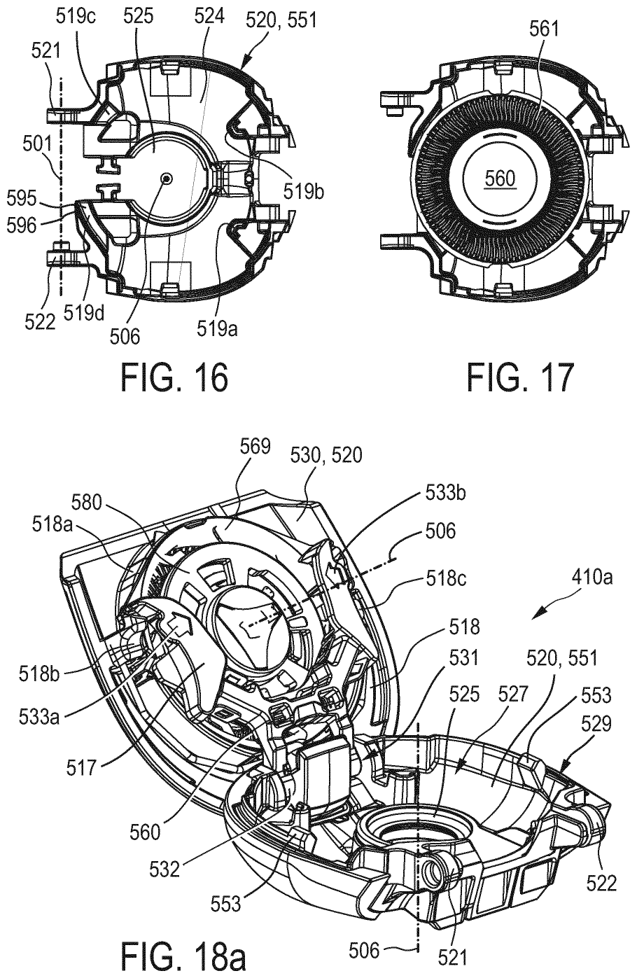

FIGS. 16, 17 and 18a-18b are detailed views of the first cutting unit 410a of the shaving unit of FIG. 11. In the following, further structural elements of the first cutting unit 410a of the shaving unit of FIG. 11 will be described with reference to FIGS. 16, 17 and 18a-18b. It is to be understood that the second cutting unit 410b of the shaving unit of FIG. 11 has similar structural elements. It is further to be understood that also the cutting units of the embodiment of the shaving unit shown in FIGS. 5-10 may have similar structural elements.

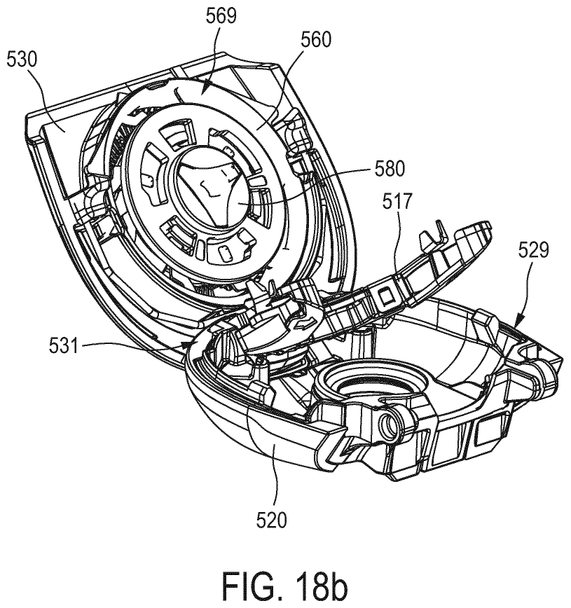

As shown in FIG. 18a, the housing 520 of the first cutting unit 410a comprises a base portion 551 and a cover portion 530. The cover portion 530 is releasably coupled to the base portion 551. In the embodiment shown in FIG. 18a, the cover portion 530 is pivotally coupled to the base portion 551 by means of a first hinge mechanism 531. By pivoting the cover portion 530 relative to the base portion 551, the housing 520 can be brought from an opened condition, as shown in FIG. 18a, to a closed condition, as e.g. shown in FIG. 11. In the closed condition of the housing 520, the cover portion 530 rests on a circumferential rim portion 529 of the base portion 551 and is releasably coupled to the base portion 551. For this purpose, the housing 520 may comprise any suitable releasable coupling mechanism, such as e.g. snapping elements 553 as shown in FIG. 18a. In the closed condition of the housing 520, the hair collecting chamber 527 provided in the base portion 551 is closed and not accessible for a user. In the opened condition of the housing 520, the cover portion 530 is released from the snapping elements 553 and, thereby, released and removed from the base portion 551, except for the permanent connection with the base portion 551 via the first hinge mechanism 531. In the opened condition of the housing 520, the hair collecting chamber 527 is accessible for the user. In alternative embodiments, the cover portion 530 may be completely removable from the base portion 551. In such alternative embodiments, a hinge mechanism connecting the cover portion 530 to the base portion 551 may not be present.

FIG. 16 shows a top view onto the base portion 551 of the housing 520. As shown in FIGS. 16 and 18a, first and second hinge elements 521, 522 are integrally formed on the base portion 551. The first and second hinge elements 521, 522 correspond with, respectively, the first hinge element 21a and the third hinge element 22a of the first cutting unit 21a in the shaving unit as shown in FIG. 4. The first and second hinge elements 521, 522 define the primary pivot axis 501 about which the cutting unit is pivotal relative to the central support member of the shaving unit. The base portion 551 is thus connected to the central support member of the shaving unit by means of a pivot structure comprising the first and second hinge elements 521, 522. FIGS. 16 and 18a further show that the base portion 551 comprises the bottom wall 524 of the housing 520, and that the opening 525 is provided in the bottom wall 524 in a central position around the axis of rotation 506.

As further shown in FIGS. 18a and 18b, the cutting unit comprises a holding component 517 which is releasably coupled to the cover portion 530 of the housing 520. In the embodiment shown in FIGS. 18a and 18b, the holding component 517 is pivotally coupled to the cover portion 530 by means of a second hinge mechanism 532. The first and second hinge mechanisms 531, 532 may be integrally formed. However, in any embodiments of the first and second hinge mechanisms 531, 532 the holding component 517 should be pivotal relative to the cover portion 530 by means of the second hinge mechanism 532 independently of a pivotal motion of the cover portion 530 relative to the base portion 551 by means of the first hinge mechanism 531. In its position shown in FIG. 18a, the holding component 517 is coupled to an inner side of the cover portion 530 by means of a releasable coupling mechanism 533a, 533b, which may be embodied as a simple snapping mechanism. In this position, the holding component 517 serves to hold the external cutting member 560 and the internal cutting member 580 in an operating position in the cover portion 530. In said operating position, the external cutting member 560 is held in the cover portion 530 by engagement of a circumferential rim 569, provided on a lower side of the external cutting member 560 facing towards the hair collecting chamber 527, with suitable positioning elements (not shown) provided on the inner side of the cover portion 530. The holding component 517 prevents the external cutting member 560 and the internal cutting member 580 from falling out of the cover portion 530 when the housing 520 is opened by pivoting the cover portion 530 relative to the base portion 551. By manually releasing the coupling mechanism 533a, 533b and pivoting the holding component 517 relative to the cover portion 530 into the position shown in FIG. 18b, the external cutting member 560 and the internal cutting member 580 can be simply removed from the cover portion 530, e.g. for cleaning the cutting members 560, 580 separately or for replacing the cutting members 560, 580 by new cutting members. In alternative embodiments, the holding component 517 may be completely removable from the cover portion 530. In such alternative embodiments, a hinge mechanism connecting the holding component 517 to the cover portion 517 may not be present.

As shown in FIG. 16, the base portion 551 of the housing 520 comprises a supporting structure 519a, 519b, 519c, 519d for supporting the external cutting member 560 in the closed condition of the housing 520. In the embodiment shown, the supporting structure 519a, 519b, 519c, 519d is provided on an inner side of the bottom wall 524 of the base portion 551, and the supporting structure 519a, 519b, 519c, 519d is arranged around the central opening 525 in a radial position, relative to the axis of rotation 506, outward of the central opening 525. In the embodiment shown, the supporting structure comprises four supporting elements 519a, 519b, 519c, 519d which are arranged with distances between each other around the axis of rotation 506. The supporting elements 519a, 519b, 519c, 519d each comprise an abutting surface 595, which extends substantially perpendicularly with respect to the axis of rotation 506 and, in the closed condition of the housing 520, faces towards the external cutting member 560. The abutting surfaces 595 of the supporting elements 519a, 519b, 519c, 519d extend in a common plane. In FIG. 16, the abutting surface of only the supporting element 519b is indicated by the reference number 595 for simplicity. Preferably, the supporting elements 519a, 519b, 519c, 519d are integrally formed at the base portion 551 of the housing 520, e.g. by means of an injection molding process, and preferably they are evenly distributed around the axis of rotation 506. In the embodiment shown, the four supporting elements 519a, 519b, 519c, 519d are arranged around the axis of rotation 506 with angular separations of approximately 90° between them. The abutting surfaces 595 of the four supporting elements 519a, 519b, 519c, 519d together form an abutment structure for the external cutting member 560 in the closed condition of the housing 520.

Starting from the opened condition of the housing 520 with the external cutting member 560 and the internal cutting member 580 being held in their operating positions in the cover portion 530 by the holding component 517 as shown in FIG. 18a, a user has to close the housing 520 by pivoting the cover portion 530 relative to the base portion 551 until the cover portion 530 is coupled to the base portion 551 by means of the snapping elements 553. When the housing 520 is closed in this way and the cover portion 530 is coupled to the base portion 551 by means of the snapping elements 553, the circumferential rim 569 of the external cutting member 560 will abut against the abutting surfaces 595 of the supporting elements 519a, 519b, 519c, 519d and will remain in abutting contact with the abutting surfaces 595. As a result, in the closed condition of the housing 520, the external cutting member 560 is directly supported by the abutting surfaces 595 of the supporting elements 519a, 519b, 519c, 519d in an axial direction parallel to the axis of rotation 506. As a result, pressure forces, which are exerted on the external cutting member 560 during use mainly in the axial direction parallel to the axis of rotation 506, will be mainly transferred by the external cutting member 560 directly to the supporting structure formed by the supporting elements 519a, 519b, 519c, 519d and, thereby, directly to the base portion 551 of the housing 520. As a result, the holding component 517 does not need to receive and transfer said pressure forces, or may need to receive and transfer only a minor portion of said pressure forces. For this reason, the holding component 517 and also the coupling mechanism 533a, 533b, by means of which is holding component 517 is releasably coupled to the cover portion 530, do not need to have a relatively rigid structure which would be required to receive and transfer said pressure forces. The holding component 517 should only be able to maintain the external cutting member 560 and the internal cutting member 580 in their operating positions in the cover portion 530 when the cover portion 530 is pivoted relative to the base portion 551 to open the housing 520. For this purpose, the holding component 517 and also the coupling mechanism 533a, 533b only need to have a relatively weak structure. Such a relatively weak structure enables an easy and simple manipulation by the user of the holding component 517 during cleaning or replacing the cutting members 560, 580.

In particular, in this embodiment the abutment structure formed by the abutting surfaces 595 of the supporting elements 519a, 519b, 519c, 519d provides, in the closed condition of the housing 520 and in said axial direction, a form-locking engagement with the external cutting member 560, wherein the external cutting member 560 is locked in the axial direction between the abutting surfaces 595 and the cover portion 530. Preferably, the abutment structure also provides a form-locking engagement with the external cutting member 560 in radial directions perpendicular to the axis of rotation 506. For this purpose, in the embodiment shown in FIG. 16, the supporting elements 519a, 519b, 519c, 519d each comprise a further abutting surface 596, which extends in a tangential direction with respect to the axis of rotation 506. In FIG. 16, the further abutting surface of only the supporting element 519b is indicated by the reference number 596 for simplicity. The further abutting surfaces 596 of the supporting elements 519a, 519b, 519c, 519d have equal distances to the axis of rotation 506. As a result, in the closed condition of the housing 520, the annular circumferential rim 569 of the external cutting member 560 is also held in a radially centered position relative to the axis of rotation 506 by the further abutting surfaces 596. FIG. 17 shows the external cutting member 560 in a position supported by the supporting elements 519a, 519b, 519c, 519d, but does not show the cover portion 530.

It is to be understood that a direct support of the external cutting member 560 by the base portion 551 of the housing 520 in the axial direction parallel to the axis of rotation 506 may also be achieved by a supporting structure different from the supporting structure having the four supporting elements 519a, 519b, 519c, 519d as described here before. The supporting structure may have a different number of supporting elements, although in embodiments having a plurality of supporting elements at least three supporting elements are preferred for a stable support of the external cutting member. Instead of being provided on the bottom wall 524 of the base portion 551, the supporting structure may alternatively be provided on e.g. a side wall of the base portion 551, e.g. as a supporting surface extending circumferentially around the hair collecting chamber 527. A skilled person will be able to define suitable alternative embodiments wherein the supporting structure is provided in the base portion of the housing such as to support the external cutting member at least in the axial direction parallel to the axis of rotation in the closed condition of the housing of the cutting unit.

The invention further relates to a shaving apparatus comprising a main housing accommodating a motor and comprising a shaving unit as described here before. In particular, the shaving unit is or may be releasably coupled to the main housing by means of the coupling member 70, 170, 470. The main housing accommodating the motor and any further components of such a shaving apparatus, such as a rechargeable battery, user interface, and electrical control circuitry, are not shown in the figures and are not described in any further detail, as they are generally known to a person skilled in the art.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

Any reference signs in the claims should not be construed as limiting the scope.

1. A shaving unit for a shaving apparatus, comprising at least a first cutting unit and a second cutting unit, wherein:
the first cutting unit comprises a first external cutting member having a plurality of hair entry openings, a first internal cutting member which is rotatable relative to the first external cutting member about a first axis of rotation, and a first housing accommodating a first hair collection chamber;
the second cutting unit comprises a second external cutting member having a plurality of hair entry openings, a second internal cutting member which is rotatable relative to the second external cutting member about a second axis of rotation, and a second housing accommodating a second hair collection chamber;
characterized in that the first housing and the second housing each comprise a bottom wall which comprises an opening which is in fluid communication with, respectively, the first hair collection chamber and the second hair collection chamber, wherein a sealing structure is provided between the opening and, respectively, the first hair collection chamber and the second hair collection chamber, said sealing structure being configured and arranged to prevent cut hairs from escaping from, respectively, the first hair collection chamber and the second hair collection chamber via the opening and to allow water to flush via the opening to, respectively, the first hair collection chamber and the second hair collection chamber.

2. A shaving unit as claimed in claim 1, wherein the sealing structure comprises opposed sealing surfaces provided on, respectively, the first internal cutting member and the second internal cutting member and on, respectively, the first housing and the second housing, and wherein at least one of said opposed sealing surfaces, and preferably the sealing structure, is symmetrical relative to, respectively, the first axis of rotation and the second axis of rotation.

3. A shaving unit as claimed in claim 2, wherein the sealing structure is provided on a central carrying member of, respectively, the first internal cutting member and the second internal cutting member and on an edge structure of the opening in the bottom wall of, respectively, the first housing and the second housing cooperating with the central carrying member.

4. A shaving unit as claimed in claim 3, wherein the sealing structure comprises a first sealing gap which is symmetrical relative to and has a main direction of extension parallel to, respectively, the first axis of rotation and the second axis of rotation, wherein the first sealing gap is bounded by a first sealing surface provided on the central carrying member of, respectively, the first internal cutting member and the second internal cutting member and by a second sealing surface provided on the edge structure of the opening in the bottom wall of, respectively, the first housing and the second housing co-operating with the central carrying member, and wherein the first sealing surface and the second sealing surface are symmetrical relative to and have a main direction of extension parallel to, respectively, the first axis of rotation and the second axis of rotation.

5. A shaving unit as claimed in claim 4, wherein the first sealing gap, the first sealing surface and the second sealing surface are annular.

6. A shaving unit as claimed in claim 4, wherein a minimum distance between the first sealing surface and the second sealing surface is in a range between 0.1 mm and 1.5 mm.

7. A shaving unit as claimed in claim 3, wherein the sealing structure comprises a second sealing gap which is symmetrical relative to and has a main direction of extension perpendicular to, respectively, the first axis of rotation and the second axis of rotation, wherein the second sealing gap is bounded by a third sealing surface provided on the central carrying member of, respectively, the first internal cutting member and the second internal cutting member and by a fourth sealing surface provided on the edge structure of the opening in the bottom wall of, respectively, the first housing and the second housing co-operating with the central carrying member, wherein the third sealing surface and the fourth sealing surface are symmetrical relative to and have a main direction of extension perpendicular to, respectively, the first axis of rotation and the second axis of rotation.

8. A shaving unit as claimed in claim 7, wherein the second sealing gap, the third sealing surface and the fourth sealing surface are annular.

9. A shaving unit as claimed in claim 7, wherein a minimum distance between the third sealing surface and the fourth sealing surface is in a range between 0.1 mm and 1.5 mm.

10. A shaving unit as claimed in claim 1, wherein the first hair collection chamber and the second hair collection chamber are annularly arranged around the opening in the bottom wall of, respectively, the first housing and the second housing.

11. A shaving unit as claimed in claim 1, wherein the first internal cutting member and the second internal cutting member are driven by, respectively, a first drive spindle and a second drive spindle extending through the opening in the bottom wall of, respectively, the first housing and the second housing.

12. A shaving unit as claimed in claim 11, wherein the shaving unit comprises a central support member comprising a coupling member by means of which the shaving unit can be releasably coupled to a main housing of the shaving apparatus, wherein the first drive spindle and the second drive spindle extend from a transmission unit to, respectively, the first cutting unit and the second cutting unit via an open space, which is present between the transmission unit and the first and the second cutting units and surrounds the central support member, and wherein the transmission unit is arranged between the coupling member and the open space.

13. A shaving unit as claimed in claim 12, wherein the coupling member accommodates a central drive shaft arranged to drive the first and second drive spindles via a transmission assembly arranged in the transmission unit.

14. A shaving unit as claimed in claim 12, wherein the first housing is pivotally mounted to the central support member by means of a first pivot axis and the second housing is pivotally mounted to the central support member by means of a second pivot axis.

15. A shaving apparatus comprising a main housing accommodating a motor, and comprising a shaving unit according to claim 1, wherein the shaving unit is releasably coupled to the main housing.
